(19) United States
(12) Patent Application Publication
(10) Pub. No.: US 2023/0290255 A1
(43) Pub. Date: Sep. 14, 2023

(54) METHOD, APPARATUS AND COMPUTER PROGRAM TO ASSIST LANDING OF AERIAL VEHICLE

(71) Applicant: THINKWARE CORPORATION, Seongnam-si (KR)

(72) Inventors: Yo Sep Park, Seongnam-si (KR); Suk Pil Ko, Seongnam-si (KR); Shin Hyoung Kim, Seongnam-si (KR)

(73) Assignee: THINKWARE CORPORATION, Seongnam-si (KR)

(21) Appl. No.: 18/107,687

(22) Filed: Feb. 9, 2023

(30) Foreign Application Priority Data
Feb. 9, 2022 (KR) 10-2022-0016983
Feb. 9, 2023 (KR) 10-2023-0017646

(51) Int. Cl. G08G 5/02; G08G 5/00; G06V 20/17; G06V 20/20; G06V 30/14

(52) U.S. Cl. CPC G08G 5/025; G08G 5/0021; G08G 5/006; G06V 20/17; G06V 20/20; G06V 30/1444

(57) ABSTRACT

Disclosed is a method of assisting landing of an aerial vehicle based on an image. The method includes acquiring an aerial vehicle landing image captured by a camera installed on the aerial vehicle; generating a landing guide object for guiding the landing of the aerial vehicle; generating a landing assistance image obtained by combining the acquired aerial vehicle landing image and the landing guide object; and displaying the generated landing assistance image.

### BACKGROUND

### 1. Field

The technical idea of the present disclosure relates to a method, apparatus, and computer program for detecting a dangerous object for an aerial vehicle, and a computer-readable recording medium including program code for executing the method of detecting a dangerous object for an aerial vehicle.

### 2. Description of Related Art

Urban air mobility (UAM) may be a next-generation mobility solution that maximizes mobility efficiency in the urban area, and has emerged to solve the rapid increase in social costs or the like such as reduced movement efficiency and logistics transportation costs due to congested traffic jam in the urban area.

In modern times where long-distance travel time has increased and traffic jam has worsened, the UAM solving these problems is considered a future innovation business.

The operation of the initial UAM used a new airframe type certified for flight in the current operating regulations and environment. For the introduction of the UAM operations, innovations in related regulations and UAM dedicated flight corridors may be introduced. New operating regulations and infrastructure enable highly autonomous traffic management.

Due to the increase in ground traffic every year, the time required for travel becomes longer, resulting in considerable economic cost loss. As a concept of city-centered air transportation that has been continuously discussed for this purpose, the limitations of the existing helicopter-type transportation have not been resolved, and as a result, high costs of operation and customer service and negative public perceptions of noise and pollution have hampered significant market growth.

This has led to the search for alternative transportation means, and the evolution of modern technology has made it possible to support the development of the concept of the UAM. In this sense, the introduction of the concept of the UAM suggests a new approach to alternative air transportation means in the urban area.

The UAM aerial vehicle is generally transportation means that constructs a next-generation advanced transportation system that safely and conveniently transports people and cargo in the urban environment based on electric power, low-noise aircraft, and a vertical take-off and landing pad. The reason why the above-described low noise and vertical take-off and landing should be premised is to increase the movement efficiency when operated in the urban area.

Due to the activation and commercialization of such unmanned aerial vehicle, the demand for effective control and management of the unmanned aerial vehicle is increasing. To this end, it is necessary to visualize a flight route of the unmanned aerial vehicle in order to allow the unmanned aerial vehicle to fly or to effectively manage the route of the unmanned aerial vehicles in flight.

In general, the currently commercialized aerial vehicle provides a route guidance service to a pilot by a method of providing the flight route and operational information through a multi-function display installed in the aerial vehicle, but since this conventional method simply displays route information between a departure point and a destination numerically or in a radar form, the conventional method has a problem in that only experienced pilots may acquire the information and the pilots may not confirm in real time the presence or absence of hazards for the external environment in relation to the aircraft operation.

In addition, while the UAM aerial vehicle flying in the urban environment having a low flight altitude is frequently exposed to dangerous objects (electric wires, birds, buildings, etc.), the pilot may only confirm a front view, so it is difficult to detect dangerous objects located on or approaching a rear surface, a side surface, or the like of the unmanned aerial vehicle.

Therefore, for the commercialization and stable flight of the UAM aerial vehicle, it is necessary to visualize a flight route on a 3D map for an intuitive and effective visualization of the flight route, and it is necessary to visualize various factors, such as whether flight is permitted, route setting, detection of ground buildings, and detection of dangerous objects, along with the flight route.

In addition, since the landing of vertical take-off and landing aerial vehicle such as helicopters is generally made based on the pilot's experience based on the pilot's field of view or information on the instrument panel, in the case of a small landing pad or obstacles appearing during the landing, there was difficulty in landing the aerial vehicle.

In addition, there was a problem that it was difficult for the pilot to know the size, slope, landing direction, etc., of the landing pad. Accordingly, it is expected that a parking assistance system such as a rear camera/around view of a vehicle will be required for a UAM.

### SUMMARY

Accordingly, an object of the present disclosure is to solve the above problems.

The present disclosure is to provide landing assistance guidance for a UAM.

In an aspect of the present disclosure, a method of assisting landing of an aerial vehicle based on an image includes: acquiring an aerial vehicle landing image captured by a camera installed on the aerial vehicle; generating a landing guide object for guiding the landing of the aerial vehicle; generating a landing assistance image obtained by combining the acquired aerial vehicle landing image and the landing guide object; and displaying the generated landing assistance image.

The detecting of the landing area from the landing image may include: calculating a matching degree between the landing guide object and the detected landing area; and controlling the landing guide objects to be differently displayed according to the calculated matching degree.

The method may further include: recognizing a digital landing marker provided in a vertiport from the vehicle landing image; and calculating a location and direction of the aerial vehicle using the recognized digital landing marker.

The vertiport may include a first area corresponding to a landing area TLOF, and in the generating of the landing guide object, a landing guide object for guiding the aerial vehicle to enter the first area of the vertiport may be generated based on the location and direction of the aerial vehicle.

The vertiport may further include a second area corresponding to a landing stage entry area (FATO) and a third area corresponding to a safety area, and in the generating of the landing guide object, landing guide objects for sequentially guiding entry into the third area, the second area, and the first area of the aerial vehicle may be generated based on the location and direction of the aerial vehicle for each of the first to third areas.

The landing guide objects for each of the first to third areas may be displayed differently.

The method may further include: generating a route guidance object based on a flight route for flight to a destination of the aerial vehicle; and displaying a route guidance image based on the generated route guidance object, in which the route guidance image may include a first route guidance image or a second route guidance image according to a horizontal distance to the aerial vehicle and the vertiport.

In the displaying of the second route guidance image, a vertiport object indicating the vertiport may be displayed on one area of a screen, and the transparency of the vertiport object may be adjusted when the aerial vehicle approaches the vertiport within a predetermined distance.

In the displaying of the second AR route guidance image, the second AR route guidance image may be displayed by adjusting a curve of the route guidance object indicating a route between the vehicle and the vertiport.

In another aspect of the present disclosure, an apparatus for assisting landing of an aerial vehicle based on an image includes: an image acquisition unit installed on the aerial vehicle to acquire a landing image of the aerial vehicle; a guidance object generation unit generating a landing guide object for guiding the landing of the aerial vehicle; a guide image generation unit generating an image obtained by combining the acquired landing image of the aerial vehicle and the landing guide object; and a display unit displaying the generated landing assistance image.

The apparatus may further include: an image analysis unit detecting a landing area from the landing image and calculating a matching degree between the landing guide object and the detected landing area, in which the display unit may display the landing guide objects differently according to the calculated matching degree.

The image analysis unit may recognize a digital landing marker provided in the vertiport from the landing image, and calculate the location and direction of the aerial vehicle using the recognized digital landing marker.

The vertiport may include a first area corresponding to a landing area TLOF, and the guidance object generation unit may generate a landing guide object for guiding the aerial vehicle to enter the first area of the vertiport based on the location and direction of the aerial vehicle.

The vertiport may further include a second area corresponding to a landing stage entry area (FATO) and a third area corresponding to a safety area, and the guidance object generation unit may generate landing guide objects for sequentially guiding entry into the third area, the second area, and the first area of the aerial vehicle based on the location and direction of the aerial vehicle for each of the first to third areas.

The landing guide objects for each of the first to third areas may be displayed differently.

The guidance object generation unit may generate a route guidance object based on a flight route for flight to a destination of the aerial vehicle, and the display unit may display the route guidance image generated based on the generated guidance object, and the guidance image may include a first route guidance image or a second route guidance image according to a horizontal distance to the vehicle and the vertiport.

The second AR route guidance image may display a vertiport object indicating the vertiport on one area of a screen, and the transparency of the vertiport object may be adjusted when the aerial vehicle approaches the vertiport within a predetermined distance.

The second AR route guidance image may be displayed by adjusting a curve of the route guidance object indicating a route between the vehicle and the vertiport.

Meanwhile, a program stored in a computer-readable recording medium according to an embodiment of the present disclosure for achieving the above object may include a program code for executing the above-described method of assisting landing of an aerial vehicle.

In addition, a computer-readable recording medium according to an embodiment of the present disclosure for achieving the above object may have a program for executing a method of assisting landing of an aerial vehicle recorded thereon.

### BRIEF DESCRIPTION OF DRAWINGS

FIG. 1 is a diagram illustrating a conceptual architecture of UAM according to an embodiment of the present disclosure.

FIG. 2 is a diagram for describing an ecosystem of the UAM according to the embodiment of the present disclosure.

FIG. 3 is a diagram for describing locations of tracks and aerodromes flying by UAM aerial vehicles in a flight corridor of the UAM according to the embodiment of the present disclosure.

FIGS. 4 and 5 are diagrams illustrating the UAM flight corridor according to the embodiment of the present disclosure.

FIG. 6 is a diagram illustrating the flight corridor of UAM for a point to point connection according to an embodiment of the present disclosure.

FIG. 7 is a diagram illustrating a development stage of the UAM.

FIG. 8 is a diagram illustrating a flight mode of aerial vehicle according to an exemplary embodiment of the present disclosure.

FIG. 9 is a block diagram illustrating a component of an apparatus for assisting landing of an aerial vehicle according to an embodiment of the present disclosure.

FIGS. 10 to 12 are diagrams illustrating landing areas according to various embodiments of the present disclosure.

FIG. 13 is a diagram illustrating a method of assisting landing of an aerial vehicle according to an embodiment of the present disclosure.

FIGS. 14 to 16 are diagrams illustrating a landing assistance screen displayed on a display unit when aerial vehicle lands in a landing area illustrated in FIG. 10.

FIGS. 17 and 18 are diagrams illustrating a landing assistance screen displayed on a display unit when the aerial vehicle lands in the landing area illustrated in FIG. 11.

FIG. 19 is a diagram illustrating a method of assisting landing of an aerial vehicle according to another embodiment of the present disclosure.

FIGS. 20 to 22 are diagrams illustrating a landing assistance guidance object according to another embodiment of the present disclosure.

FIGS. 23 to 37 are diagrams illustrating a method of displaying a guidance object for guidance of UAM aerial vehicle according to an embodiment of the present disclosure.

FIG. 38 is a block diagram illustrating UAM aerial vehicle according to an embodiment of the present disclosure.

### DETAILED DESCRIPTION

Hereinafter, detailed embodiments of the present disclosure will be described with reference to the accompanying drawings. The following detailed descriptions are provided to help a comprehensive understanding of methods, devices and/or systems described herein. However, the embodiments are described by way of examples only and the present disclosure is not limited thereto.

In describing the embodiments of the present disclosure, when a detailed description of well-known technology relating to the present disclosure may unnecessarily make unclear the spirit of the present disclosure, a detailed description thereof will be omitted. Further, the following terminologies are defined in consideration of the functions in the present disclosure and may be construed in different ways by the intention of users and operators. Therefore, the definitions thereof should be construed based on the contents throughout the specification. The terms used in the detailed description is merely for describing the embodiments of the present disclosure and should in no way be limited. Unless clearly used otherwise, an expression in the singular form includes the meaning of the plural form. In this description, expressions such as “including” or “comprising” are intended to indicate certain characteristics, numbers, steps, operations, elements, some or combinations thereof, and it should not be interpreted to exclude the existence or possibility of one or more other characteristics, numbers, steps, operations, elements, parts or combinations thereof other than those described.

In addition, terms ‘first’, ‘second’, A, B, (a), (b), and the like, will be used in describing components of embodiments of the present disclosure. These terms are used only in order to distinguish any component from other components, and features, sequences, or the like, of corresponding components are not limited by these terms.

Urban air mobility (UAM) used throughout this specification comprehensively refers to an urban transportation system that transports people and cargo using aircraft rather than ground transportation means. An airframe applied to a UAM operation may include a fixed-wing aircraft and personal air vehicle (PAV) type capable of horizontal take-off and landing, also known as vertical take-off and landing (VTOL) or conventional take-off and landing (CTOL).

More specifically, the urban air mobility (UAM) enables highly automated, passenger- and cargo-transporting air transport services in and around the urban area.

Urban air traffic is an aggregation of advanced air mobility (AAM) being developed by governments and industries. The AAM enables transportation of people and cargo in regional, local, international and urban environments. Among those, the UAM is being operated to suit movement in the urban area.

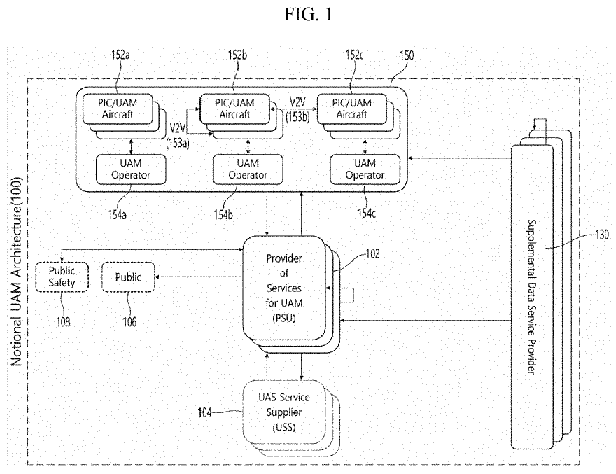

FIG. 1 is a diagram illustrating a conceptual architecture of UAM according to an embodiment of the present disclosure. Hereinafter, referring to FIG. 1, a conceptual architecture 100 of UAM that may be defined in an environment for UAM operation management will be described.

First, terms generally used in this specification will be defined to help understanding of the present disclosure.

A UAM aerodrome refers to a location where a UAM flight operation departs and arrives, a UAM aerial vehicle refers to aircraft capable of performing a UAM operation, a UAM flight corridor is a three-dimensional airspace with performance requirements for operating at a location where tactical air traffic control (ATC) separation services are not provided or are crossed, and an airspace assigned for flight of a UAM aerial vehicle to prevent collisions between a non-UAM aerial vehicle and the UAM aerial vehicle.

The UAM operation refers to transporting passengers and/or cargo from a UAM aerodrome at any one location to a UAM aerodrome at another location.

The UAM operation information includes, but not limited thereto, as information necessary for UAM operation, UAM operation identification information, UAM flight corridor information to be flown, UAM aerodrome information, and UAM operation event information (UAM aerodrome departure time, arrival time, etc.

A UAM operator represents an organization that manages overall UAM operations and performs each UAM operation. The UAM operator corresponds to a server that includes a network unit for managing a flight plan (or intent) of each UAM or a PIC UAM aerial vehicle and transmitting and receiving real-time information to and from each UAM or the PIC UAM aerial vehicle, a storage unit for storing information necessary for flight of each UAM/PIC UAM, a processor for monitoring the flight of each UAM/PIC UAM aerial vehicle and controlling autonomous flight, and a display unit for displaying a flight status of each UAM/PIC UAM aerial vehicle in real time.

An unmanned aircraft system traffic management (UTM) operator is an operator who utilizes UTM-specific services to perform low-altitude unmanned aircraft system (UAS) operation, and corresponds to a server that includes a network unit for transmitting and receiving information to and from each aerial vehicle in real time, a storage unit for storing information necessary for each flight, a processor for monitoring the flight of each aerial vehicle and controlling autonomous flight, and a display unit for displaying a flight status of each aerial vehicle in real time.

In general, since aircraft tends to comply with the regulations of ICAO and the Federal Aviation Administration (FAA), which are international organizations, this specification will also describe the UAM concept from the viewpoint of the FAA establishing regulations for safe operation of UAM.

First, in order to prevent accidents such as a midair collision between the UAM aerial vehicle or between the UAM aerial vehicle and the non-UAM aerial vehicle, it should be possible for the UAM operators to access FAA National Airspace System (NAS) data through FAA-industry data exchange protocols.

This approach enables authenticated data flow between the UAM operators and FAA operating systems. Referring to FIG. 1, UAM operators 154a, 154b, and 154c according to the present disclosure may be configured by a distributed network utilizing an interoperable information system.

In addition, the UAM operators 154a, 154b, and 154c may perform the UAM operation in a scheduled service or on-demand service method through a request of an individual customer or an intermodal operator.

The UAM operators 154a, 154b, and 154c are responsible for all aspects of regulatory compliance and UAM operational execution.

Hereinafter, the use of the term “operator” in this specification refers to an airspace user who has chosen to be operated through cooperative management within the UAM environment. More specifically, the operator may include a UAM operating system including electronic devices that include a processor, memory, database, network interface, communication module, etc., that are connected to a wired/wireless network to perform various controls and management required for the UAM operation.

The UAM operators 154a, 154b, and 154c may be closely connected to PIC/UAM aerial vehicles 152a, 152b, and 152c to exchange various information (flight corridor information, airframe condition information, weather information, aerodrome information, arrival time, departure time, map data, etc.) for flight of the plurality of PIC/UAM aerial vehicles 152a, 152b, and 152c in real time.

A volume of a group of the PIC/UAM aerial vehicles 152a, 152b, and 152c that each of the UAM operators 154a, 154b, and 154c may manage may be set differently according to the capability of the UAM operators 154a, 154b, and 154c. In this case, the capability information of the UAM operators 154a, 154b, and 154c may include the number of UAM aerial vehicles that may be accessed simultaneously, the number of UAM aerial vehicles that may be controlled simultaneously, a network traffic processing speed, processor capability of a server system, and a range of a control area, etc.

Among the plurality of PIC/UAM aerial vehicles 152a, 152b, and 152c, the PIC/UAM aerial vehicle controlled by the same UAM operators 154a, 154b, and 154c may each be grouped into one group and managed. In addition, inter-airframe vehicle to vehicle (V2V) communication 153a may be performed between the PIC/UAM aerial vehicles 152a, 152b, and 152c within the grouped group, and information related to operation may be shared through V2V communication between the PIC/UAM aerial vehicles 152a, 152b, and 152c included in different groups.

To determine desired UAM operational flight plan information such as location of flight (e.g., aerodrome locations), route (e.g., specific UAM corridor(s)), and desired flight time, the UAM operators 154a, 154b, and 154c acquire current status/conditions from at least one of information (environment, situational awareness information, strategic operational demand information, and UAM aerodrome availability) that a PSU 102 and a supplemental data service provider (SDSP) 130 provide.

The UAM operators 154a, 154b, and 154c should provide the flight plan and navigation data to the PSU 102 to be operated within or cross the UAM flight corridor.

In addition, the UAM operators 154a, 154b, and 154c should set planning data in advance for proper preparation when an off-nominal event occurs. The planning data includes understanding of alternative landing sites and the airspace classes bordering the UAM flight corridor(s) for operations.

When all preparations for the UAM operation are completed, the UAM operators 154a, 154b, and 154c provide the information related to the corresponding UAM operation to the PSU 102. In this case, the UAM operators 154a, 154b, and 154c may suspend or cancel the flight of the UAM aerial vehicle until a flight permission message is received from the PSU 102. In another embodiment, even if the UAM operators 154a, 154b, and 154c do not receive the flight permission message from the PSU 102, the UAM operators 154a, 154b, and 154c may start the flight of the UAM aerial vehicle by themselves.

In FIG. 1, the pilot in command (PIC) represents a case where a person responsible for operation and safety of the UAM in flight is on board the UAM aerial vehicle.

The provider of services for UAM (PSU) 102 may serve as an agency that assists the UAM operators 154a, 154b, and 154c to meet UAM operational requirements for safe and efficient use of airspace.

In addition, the PSU 102 may be closely connected with stakeholders 108 and the public 106 for public safety.

To support the capability of the UAM operators 154a, 154b, and 154c to meet the regulations and operating procedures for the UAM operation, the PSU 102 provides a communication bridge between UAMs and a communication bridge between PSUs and other PSUs through the PSU network 206.

The PSU 102 collects the information on the UAM operation planned for the UAM flight corridor through the PSU network 206, and provides the collected information to the UAM operators 154a, 154b, and 154c to confirm the duty performance capability of the UAM operators 154a, 154b, and 154c. Also, the PSU 102 receives/exchanges the information on the UAM aerial vehicles 152a, 152b, and 152c through the UAM operators 154a, 154b, and 154c during the UAM operation.

The PSU 102 provides the confirmed flight plan to other PSUs through the PSU network 206.

In addition, the PSU 102 distributes notification of an operating area in the flight plan (constraints, restrictions), FAA operational data and advisories, and weather and additional data to the UAM operators 154a, 154b, and 154c.

The PSU 102 may acquire UTM flight information through a UAS service supplier (USS) 104 network, and the USS network may acquire the UAM flight information through the PSU network 206.

In addition, the UAM operators 154a, 154b, and 154c may confirm the flight plan shared through the PSUs 102 and other UAM operators, and flight plan information for other flights in the vicinity, thereby controlling safer UAM flights.

The PSU 102 may be connected to other PSUs through the PSU networks 206 to acquire subscriber information, FAA data, SDSP data, and USS data.

The UAM operators 154a, 154b, and 154c and the PSU 102 may use the supplemental data service provider (SDSP) 130 to access support data including terrain, obstacles, aerodrome availability, weather information, and map data for a three-dimensional space. The UAM operators 154a, 154b, and 154c may access the SDSP 130 directly or through PSU network 206.

The USS 104 serves to support the UAS operation under the UAS traffic control (UTM) system.

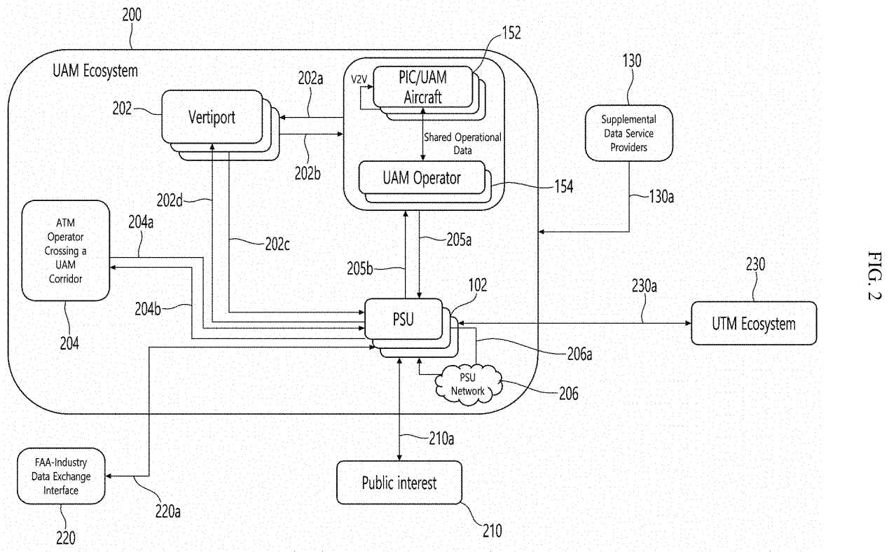

FIG. 2 is a diagram for describing an ecosystem of the UAM according to the embodiment of the present disclosure.

Referring to FIG. 2, the PIC/UAM aerial vehicle 152 and the UAM operator 154 transmit UAM operational intent information and UAM real-time data to a vertiport management system 202 (202a), and the vertiport management system 202 transmits vertiport capacity information and vertiport status information to the PIC/UAM aerial vehicle 152 and the UAM operator 154 (202b).

In addition, the PIC/UAM aerial vehicle 152 and the UAM operator 154 transmit a UAM operational intent request message, UAM real-time data, and UAM operation departure phase status information to the PSU 102 (205a).

The PSU 102 transmits UAM notifications, UAM corridor information, vertiport status information, vertiport acceptance information, and UAM operation intent response message to the PIC/UAM aerial vehicle 152 and the UAM operator 154 (205b). In this case, the UAM operational intent response message includes a response message informing of approval/deny, etc., for the UAM operational intent request.

The vertiport management system 202 transmits the UAM operation departure phase status information, the vertiport status information, and the vertiport acceptance information to the PSU 102 (202c). The PSU 102 transmits the UAM operational intent information and UAM real-time data to the vertiport management system 202 (202d).

In FIG. 2, when aerial vehicles (that is, non-UAMs) other than the UAM aerial vehicles need to cross the UAM flight corridor, the ATM operator 204 crossing the UAM flight corridor transmits a UAM flight corridor crossing request message to the PSU 102 (204a), and the PSU 102 transmits a response message to the UAM flight corridor crossing request message (204b).

In addition, in FIG. 2, the PSU 102 may perform a procedure for synchronizing UAM data with PSUs connected through the PSU network 206.

In particular, the PSU 102 may exchange information with other PSUs through the PSU network 206 to enable UAM passengers and UAM operators to smoothly provide UAM services (e.g., exchange of flight plan information, notification of UAM flight corridor status, etc.).

In addition, the PSU 102 may prevent risks such as collisions with the UAM aerial vehicle and the unmanned aerial vehicle, and transmit and receive UAM off-nominal operational information and UTM off-nominal operational information to and from the UTM ecosystem 230 for smooth control in real time (230a).

In addition, the PSU 102 shares FAA and UAM flight corridor availability, UAM flight corridor definition information, NAS data, a UAM information request, and response to the UAM information request, UAM flight corridor status information, and UAM off-nominal operational information through the FAA industrial data exchange interface 220 (220a).

In addition, the PSU 102 may transmit and receive the UAM information request and the response to the UAM information request to and from a public interest agency system 210. The public interest agency system 210 may be an organization defined by a management process (e.g., FAA, CBR) to have access to the UAM operation information. This access may support activities that include public right to know, government regulation, government guaranteed safety and security, and public safety. Examples of public interest stakeholders include regional law enforcement agencies and United States federal government agencies.

In addition, the UAM ecosystem 200 may receive supplemental data such as terrain information, weather information, and obstacles from supplemental data service providers (SDSP) 130 (130a), and thus, generate information necessary for safe operation of the UAM aerial vehicle.

In an embodiment of the present disclosure, the PSU 102 may confirm a corresponding UAM flight corridor use status through UAM flight corridor use status (e.g., active, inactive) information. For example, when the UAM flight corridor use status information is set to “active,” the PSU 102 may identify whether the UAM flight is scheduled or whether the UAM aerial vehicle is currently flying in the corresponding flight corridor, and when the UAM flight corridor use status information is set to “inactive”, the PSU 102 may identify that there is no UAM aerial vehicle currently flying in the corresponding flight corridor.

In addition, the PSU 102 may store operation data related to the flight of the UAM aerial vehicle in an internal database in order to identify a cause of an accident of the UAM aerial vehicle in the future.

These key functions allow the PSU 102 to provide the FAA with cooperative management of the UAM operation without being directly involved in UAM flight.

The PSU 102 may perform operations related to flight planning, flight plan sharing, strategic and tactical conflict resolution, an airspace management function, and an off-nominal operation.

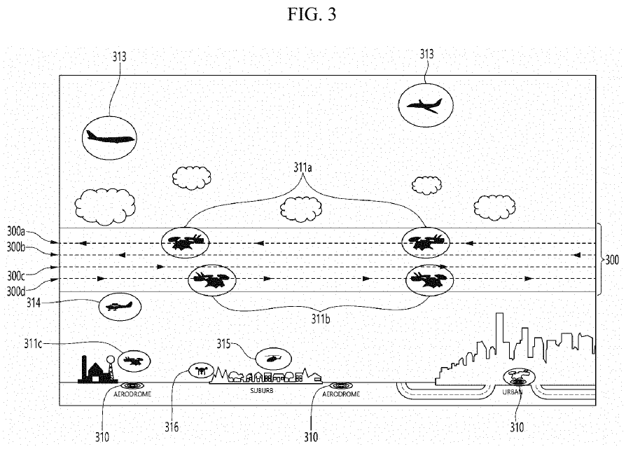

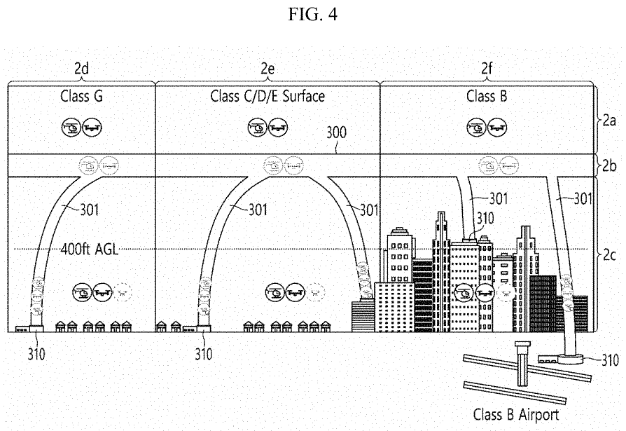

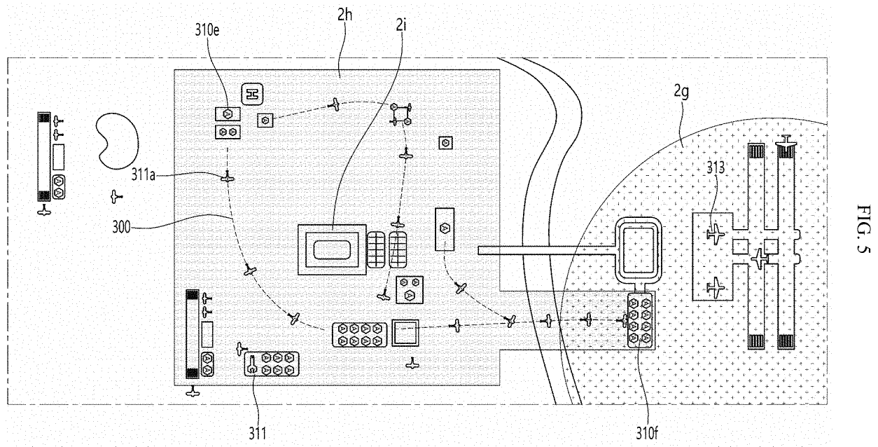

FIG. 3 is a diagram for describing locations of tracks and aerodromes on which UAMs fly within a UAM flight corridor according to an embodiment of the present disclosure, and FIGS. 4 and 5 are diagrams illustrating the UAM flight corridor according to the embodiment of the present disclosure.

It will be described with reference to FIGS. 3 to 5 below.

Referring to FIG. 3, for efficient and safe flight of UAM aerial vehicles 311a and 311b within a UAM flight corridor 300 according to an embodiment of the present disclosure, a plurality of tracks 300a, 300b, 300c, and 300d are provided within the corresponding flight corridor. Each of the tracks 300a, 300b, 300c, and 300d has different altitudes to prevent a collision between the UAM aerial vehicles 311a and 311b, and the number of tracks will be differently set depending on the capacity of the corresponding flight corridor 300.

A UAM aerodrome 310 is an aerodrome that meets capability requirements to support UAM departure and arrival operations. The UAM aerodrome 310 provides current and future resource availability information for UAM operations (e.g., open/closed, pad availability) to support UAM operator planning and PSU strategic conflict resolution. The UAM operator 154 may directly use the UAM aerodrome 310 through the PSU network 206 or through the SDSP 130.

In FIG. 3, the UAM flight corridor 300 should be set to enable the safe and efficient UAM operation without a tactical ATC separation service. Therefore, the UAM flight corridor 300 should be set in relation to the capabilities (e.g., aerial vehicle performance, UAM flight corridor structure, and UAM procedure) of the UAM operator 154.

Additionally, the PSU 102 or the UAM operator 154 may be operated differently within the UAM flight corridor 300 according to operation performance (e.g., aircraft performance envelope, navigation, detection-and-avoidance (DAA)) and participation conditions (e.g., flight intention sharing, conflict resolution within the UAM corridor) of the UAM flight corridor 300.

In addition, the PSU 102 or the UAM operator 154 may set performance and participation requirements of the UAM flight corridor 300 differently between the UAM corridors.

Specifically, the PSU 102 or the UAM operator 154 may variably set the range (flight altitude range) of the UAM flight corridor 300 in consideration of information such as the number of UAM aerial vehicles using the corresponding UAM flight corridor 300, an occupancy request of managements systems (e.g., UTM, ATM) for other aerial vehicles for the corresponding airspace, a prohibited area, and a flight limit altitude.

In addition, the PSU 102 or the UAM operator 154 may share, as the status information for the set UAM flight corridor 300, the UAM flight information (flight time, flight altitude, track ID within the flight corridor, etc.) within the UAM flight corridor with other UAM operators and/or PSUs through the PSU network 206.

Also, the PSU 102 or the UAM operator 154 may set the number of tracks 300a, 300b, 300c, and 300d in the flight corridor according to the range of the UAM flight corridor 300. It is preferable that the corresponding tracks 300a, 300b, 300c, and 300d are defined to have a safe guard set so that the PIC/UAM aerial vehicle 152 flying along the corresponding tracks does not collide with each other. Here, the safe guard may be set according to the height of the UAM aerial vehicle, or even when the UAM aerial vehicle temporarily deviates from a track assigned thereto due to a bird strike or other reasons, the safe guard may be a space set so as not to collide with other UAM aerial vehicles flying on the nearest neighbor track above and below the corresponding track.

In addition, the PSU 102 or the UAM operator 154 may set the tracks 300a, 300b, 300c, and 300d within the flight corridor according to the range of the UAM flight corridor 300, assign a track identifier (Track ID), which is an identifier in the flight corridor 300 for distinguishing the set tracks, and notify the PIC/UAM aerial vehicle 152 scheduled to fly within the corresponding UAM flight corridor 300 of the assigned track ID.

As a result, the PSU 102 or the UAM operator 154 may monitor in real time whether the PIC/UAM aerial vehicle 152 flying in the corresponding flight corridor 300 are flying along each assigned track ID, and when the PIC/UAM aerial vehicle 152 deviate from the assigned track ID, the PSU 102 or the UAM operator 154 may transmit a warning message to the corresponding PIC/UAM aerial vehicle 152, or remotely control the corresponding PIC/UAM aerial vehicle 152.

In the operating environment of the National Airspace System (NAS), the operation type, regulations and procedures of the airspace may be defined to enable the operation of the aerial vehicle, so the airspace according to the operating environment of the UAM, UTM, and air traffic management (ATM) may be defined as follows.

A UAM aerial vehicle 311 may be operated in the flight corridor 300 set above the area in which the UAM aerodromes 310 are located. In this case, the UAM aerial vehicle 311 may be operated in the above-described operable area based on the performance predefined in designing the airframe.

The unmanned aerial system traffic management (UTM) supports the safe operation of the unmanned aerial system (UAS) in an uncontrolled airspace (class G) below 400 ft (120 m) above ground level (AGL) and controlled airspaces (class B, C, D and, E).

On the other hand, the air traffic management (ATM) may be applied in the whole airspace.

In order to operate the UAM aerial vehicle 311, a fixed-wing aircraft 313, and helicopters 315 inside and outside the UAM flight corridor 300 according to the embodiment of the present disclosure, all aircrafts within the UAM flight corridor 300 operate under the regulations, procedures and performance requirements of the UAM. The case of the fixed-wing aircraft 313 and the aircraft controlled by the UTM may cross the UAM flight corridor 300.

In addition, it is preferable that the helicopter 315 and the UAM aerial vehicle 311 are operated in the UAM flight corridor 300, and outside the UAM flight corridor 300, in the outside of the UAM flight corridor 300, the helicopter 315 and the UAM aerial vehicle 311 comply with the operation form, the airspace class, and the flight altitude according to the regulations for the air traffic management (ATM) and the regulations for the UTM.

Of course, the same regulations as described above are applied to visual flight rules (VFR) 314 or unmanned drones 316 in which a pilot recognizes surrounding obstacles with his eyes and flies in a state in which a surrounding visual distance is wide.

The operation of each aerial vehicle described above does not depend on the airspace class, and may be applied based on the inside and outside of the flight corridor 300 of the UAM. Meanwhile, the airspace class may be classified according to purpose such as a controlled airspace, an uncontrolled airspace, a governed airspace, and an attention airspace, or classified according to provision of air traffic service.

The UAM flight corridor 300 allows the UAM aerial vehicle to be operated more safely and effectively without the technical separation control service (management of interference with other aerial vehicles for safety) according to the ATM. In addition, it is possible to help accelerate the operating tempo related to the operating capability, structure, and procedures of the UAM aerial vehicle. In addition, in the present disclosure, by defining the UAM flight corridor 300, it is possible to provide a clearer solution to agencies having an interest in the related field.

The UAM flight corridor 300 may be designed to minimize the impact on the existing ATM and UTM operations, and should be designed to not only consider the regional environment, noise, safety, and security, but also satisfy the needs of customers.

In addition, the effectiveness of the UAM flight corridor 300 should be consistent with the operation design (e.g., changing the flight direction during take-off and landing at a nearby airport or setting direct priority between opposing aircraft) of the ATM. Of course, the UAM flight corridor 300 may be designed to connect the locations of the UAM aerodromes 310 located at two different points for point-to-point connection.

The UAM aerial vehicle 311 may fly along a take-off and landing passage 301 connecting the flight corridor 300 in the aerodrome 310 to enter the UAM flight corridor 300, and the take-off and landing passage 301 may also be designed in a way that minimizes the impact on ATM and UTM operations and should be designed in a way that satisfies the requirements of customers as well as considering the regional environment, noise, safety, security, etc.

The airspace or operation separation within the UAM flight corridor 300 may be clarified through a variety of strategies and technologies. As a preferred embodiment for the airspace or operation separation within the UAM flight corridor 300, a collision may be strategically prevented based on a common flight area, and an area may be technically assigned to the UAM operator 154. In this case, in an embodiment of the present disclosure, PIC and aircraft performance or the like may be considered when separating the airspace or operation within the UAM flight corridor 300.

In addition, since the UAM operator 154 is responsible for safely conducting the UAM operation in association with aircraft, weather, terrain and hazards, it is also possible to separate the UAM flight corridor 300 through the shared flight intention/flight plan, awareness, strategic anti-collision, and establishment of procedural rules.

For example, it can be seen that the UAM flight corridor 300 in FIG. 3 is separated into two airspaces based on the flight direction of the UAM aerial vehicle 311a and 311b. In this case, in FIG. 3, in a relatively high airspace within the UAM flight corridor 300, the UAM aerial vehicle 311a may fly in one direction (from right to left), and in a relatively low airspace, the UAM aerial vehicle 311b may fly in a direction (from left to right) opposite to the one direction.

Meanwhile, the UAS service provider (USS) 104 and the SDSP 130 may provide the UAM operator 154 with weather, terrain, and obstacle information data for the UAM operation.

The UAM operator 154 may acquire the data at the flight planning stage to ensure updated strategic management during the UAM operation and flight, and the UAM operator 154 may continuously monitor the weather during the flight based on the data to make a plan or take technical measures to prevent emergencies such as collisions from occurring within the flight corridor.

Accordingly, the UAM operator 154 is responsible for identifying operation conditions or flight hazards that may affect the operation of the UAM, and this information should be collected during flight as well as pre-flight to ensure safe flight.

The PSU 102 may provide other air traffic information scheduled for cross operation within the UAM flight corridor 300, meteorological information such as meteorological wind speed and direction, information on hazards during low altitude flight, information on special airspace status (airspace prohibited areas, etc.), the availability for the UAM flight corridor 300, etc.

In addition, during the UAM operation, the identification information and location information of the UAM aerial vehicle 311 may be acquired through a connected network between the UAM operator 154 and the PSU 102, but is not preferably provided by automatic dependent surveillance-broadcast (ADS-B) or transponder.

Since the operation of UAM ultimately aims at the unmanned autonomous flight, the identification information and location information of the UAM aerial vehicle 311 are acquired or stored by the UAM operator 154 and the PSU 102, and are preferably used for the operation of the UAM.

Meanwhile, referring to FIG. 4, due to the characteristics of UAM that is operated to suit urban and suburban environments, the aerodrome 310 may be installed in several densely populated regions, and each aerodrome 310 may set a take-off and landing passage 301 connected to the UAM flight corridor 300.

The airspace according to the embodiment of the present disclosure may be divided into an airspace 2a of an area in which the fixed-wing aircraft 313 and rotary-wing aircraft 315, etc., are allowed to fly only according to the instrument flight Rules (IFR) vertically depending on altitude, an airspace 2b in which the UAM flight corridor 300 is formed and airspace 2c in which the take-off and landing passage 301 of the UAM aerial vehicle is formed.

The aerial vehicle illustrated in FIG. 4 may be divided into a UAM aerial vehicle (dotted line) flying in the UAM flight corridor 300, an aerial vehicle (solid line) flying in the airspace according to the operating environment of the air traffic management (ATM), and an aerial vehicle (unmanned aircraft system) (UAS) (dashed line) flying at low altitude operated by the unmanned aircraft system traffic management (UTM) operator.

The airspace according to the embodiment of the present disclosure may be horizontally divided into a plurality of airspaces 2d, 2e, and 2f according to the above-described airspace class.

Also, referring to FIG. 5, the airspace may be divided into an airspace 2g divided into an existing air traffic control (ATC) area and an area 2h where UAM operation or control is performed according to the operation or control area. Of course, the ATC control area 2g and the UAM operation or control area 2h may overlap depending on circumstances.

In the area 2h where the UAM operation or control is performed, a plurality of aerodromes 310e and 310f may exist for the point-to-point flight of the UAM aerial vehicle 311, and a prohibited area 2i may be set in the area 2h where the UAM operation or control is performed.

The UAM flight corridor 300 for the point-to-point flight may be set within the area 2h where the UAM operation or control is performed, except for the area set as the prohibited area 2i.

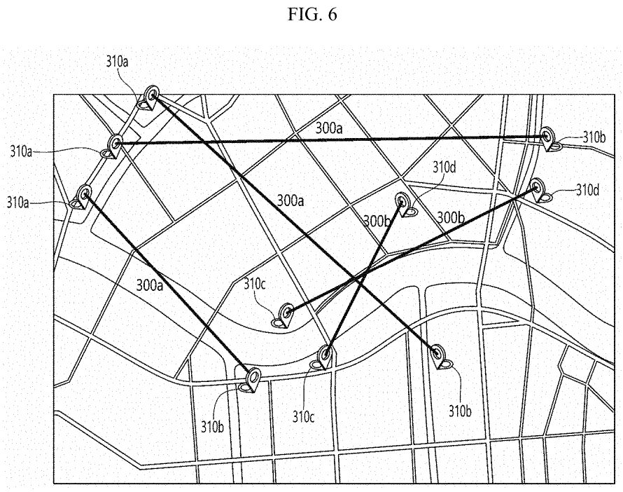

FIG. 6 is a diagram illustrating the aviation corridor of UAM for the point to point connection according to an embodiment of the present disclosure.

This will be described with reference to FIG. 6 below.

The flight corridors 300a and 300b of the UAM aerial vehicle may connect an aerodrome 310a in one region and an aerodrome 310b in another region. The connection between these points may be established within an area excluding special airspace such as the prohibited area 2i within the area 2h where the above-described UAM operation or control is performed, and the altitude at which the UAM flight corridor 300 is set may be set within the airspace 2b in which the UAM flight corridor 300 is set. Here, the aerodrome 310 may refer to, for example, a vertiport in which an aerial vehicle capable of vertical take-off and landing may take-off and land.

Hereinafter, the operation of the above-described UAM will be described.

The UAM may be operated in consideration with the operation within the UAM flight corridor 300, the strategic airspace separation, the real-time information exchange between the UAM operator 154 and the UAM aerial vehicle 311, the performance conditions of the UAM airframe, etc.

The flight of the UAM may be generally divided into a stage of planning a flight in a pre-flight stage, a take-off stage in which the UAM takes off from the aerodrome 310 and enters a vertical take-off and landing passage 51 and climbs, a climb stage in which the UAM climbs from the aerodrome 310 and enters the flight corridor 300, a cruise stage in which the UAM moves along the flight corridor 300, a descend and landing stage in which the UAM enters the take-off and landing passage 51 from the flight corridor 300, and then, descends and enters the aerodrome 310, a disembarking stage after flight, and operation inspection stage.

The operation in each stage may be performed by being divided into the UAM operator 154, the PSU 102 (or SDSP 130), the FAA, the aerodrome operator, and the PIC/UAM passenger. The PIC/UAM passenger may be understood as a concept including both a person who boards the airframe and controls the airframe and passengers who move through the airframe.

In the pre-flight planning stage, the UAM operator 154 may submit the flight plan to the FAA and confirm the passenger list and destination.

The PSU 102 may remove factors that may hinder flight or plan a strategy for the case where an off-nominal situation occurs.

The FAA may review the flight plan submitted by the UAM operator 154 to determine whether to approve the operational plan, and transmit the determination back to the UAM operator 154.

The aerodrome operator may inspect passengers and cargo, perform boarding of passengers, confirm whether the area around the aerodrome 310 is cleared for departure, and notify the UAM operator 154 and/or the PSU 102 of the information on the confirmed result.

The PIC/UAM passenger may finally confirm all hardware and software systems of the UAM aerial vehicle 311 for departure, and notify the UAM operator 154 and/or the PSU 102 through a communication device.

After the FAA notifies the approval of the UAM operation plan, it maintains the authority for the airspace in which the flight route is established in the PIC/UAM flight, but the UAM operators 154 who actually operate the UAM aerial vehicle and/or the PSU 102 directly control/govern the UAM flight operation, so it is preferable that the FAA does not actively participate in the UAM flight.

In addition, in the take-off stage in which the UAM aerial vehicle takes off the aerodrome 310 and climbs, the UAM operator 154 may approve a taxi request or a take-off request of a runway of an airport of the UAM aerial vehicle and transmit a response message thereto to each UAM.

The PSU 102 may sequentially assign priority to each of the plurality of UAM aerial vehicles to prevent the collision between the UAM aerial vehicles and to smoothly control the aerodrome. The PSU 102 controls and monitors only the UAM aerial vehicle to which priority is assigned to move to the runway or take-off.

Before taking off of the UAM aerial vehicle, the aerodrome operator may confirm the existence of obstacles that hinder the takeoff of the UAM around the aerodrome, and may approve the takeoff of the UAM aerial vehicle if there are no obstacles. The PIC/UAM passenger who has received the take-off approval may proceed with the take-off procedure of the UAM aerial vehicle.

In the climb stage in which the UAM aerial vehicle enters the take-off and landing passage 301 from the aerodrome 310, and then climbs and enters the flight corridor 300 and the cruise stage in which the UAM aerial vehicle moves along the flight corridor 300, the UAM operator 154 monitors whether the PIC/UAM is flying according to the flight plan or whether the overall flight operation plan is being followed. In addition, the UAM operator 154 may monitor the status of the UAM aerial vehicle 311 while exchanging data with the PSU 102 and the UAM aerial vehicle 311 in real time and update information and the like if necessary.

The PSU 102 may also monitor the status of the UAM aerial vehicle 311 while exchanging data with the UAM operator 154 and the UAM aerial vehicle 311 in real time, and may deliver the updated operation plan to the UAM operator 154 and the UAM aerial vehicle 311, if necessary.

When the UAM aerial vehicle 311 enters the cruise stage, the aerodrome operator no longer actively participates in the flight of the UAM aerial vehicle 311. In addition, the PIC/UAM aerial vehicle 311 may execute the take-off and cruise procedures, perform collision avoidance or the like through the V2V data exchange, monitor the system of the aerial vehicle in real time, and provide the UAM operator 154 and the PSU 102 with the information such as the aircraft status.

In the descending and landing stage, since the UAM aerial vehicles 152 and 311 have reached near a destination, the cruise mode is terminated and descends and enters the aerodrome 310 after entering the take-off and landing passage 301 from the flight corridor 300. Even during the descend and landing stage, the UAM operator 154 may continuously monitor the flight status/airframe status of the UAM aerial vehicles 152 and 311 and at the same time, monitor whether the flight of the UAM aerial vehicles 152 and 311 complies with a predefined flight operation plan.

In addition, the UAM aerial vehicles 152 and 311 may be assigned a gate number or gate identification information to land on the aerodrome through communication with the aerodrome operator while entering the take-off and landing passage 301, and confirm whether the current airframe status is ready for landing (landing gear operation, flaps, rotor status, output status, etc.).

The PSU 102 may request the approval of the landing permission of the UAM aerial vehicle 311 from the aerodrome operator, and transmit, to the UAM aerial vehicle 311, information including compliance matters for moving from the current flight corridor or location of the UAM aerial vehicle 311 to the UAM aerodrome 310 permitted to land.

In addition, the UAM aerial vehicle 311 may confirm whether the aerodrome 310 is in a clear status (status in which all elements that may be obstacles to the landing of the UAM aerial vehicle 311 are removed) through communication with the UAM aerodrome 310, the PSU 102, and the UAM operator 154, and after the landing of the UAM aerial vehicle 311 is completed, the UAM aerial vehicle 311, the PSU 102, and the UAM operator 154 may all identify the end of the flight operation of the corresponding UAM aerial vehicle.

When receiving the landing request from the UAM aerial vehicle 311, the aerodrome operator confirms a gate cleared out of the aerodrome. In addition, when the aerodrome operator secures whether the landing is possible for the confirmed gate, the aerodrome operator transmits landing permission message including the gate ID or gate number to the UAM aerial vehicle 311, and assigns a gate corresponding to a landing zone included in the landing permission message to the UAM aerial vehicle 311.

Also, when receiving the landing permission message from the aerodrome operator, the UAM aerial vehicle 311 lands at a gate assigned thereto according to a predetermined landing procedure.

The PIC/UAM passengers may perform the take-off and landing procedure of the UAM aerial vehicle 311, and may perform procedures of preventing collisions with other UAM aerial vehicles while maintaining V2V communication and moving to a runway after landing.

The stage of planning the flight of the UAM aerial vehicle 311 starts with receiving the flight requirements of the UAM aerial vehicle 311 for the UAM operator 154 to fly point to point between the first aerodrome and the second aerodrome. In this case, the UAM operator 154 may receive data (e.g., weather, situation awareness, demand, UAM aerodrome availability, and other data) for the flight of the UAM aerial vehicle 311 from the PSU 102 or SDSP 130.

In all the stages related to the UAM operation, the UAM operator 154 and the PSU 102 not only need to confirm the identification and location information of the UAM aerial vehicle in real time, but also the PIC/UAM and UAM operator 154 needs to monitor the performance/condition of the aerial vehicle in real time to identify whether the flight status of the UAM aerial vehicle 311 is off-nominal.

Meanwhile, the UAM aerial vehicle 311 may have an off-nominal status for various reasons such as weather conditions and airframe failure. The off-nominal status may refer to an operating situation in which the UAM aerial vehicle 311 does not follow a flight plan planned before flight due to various external or internal factors.

Two cases may be assumed as the case in which the off-nominal flight condition occurs in the UAM aerial vehicle 311. The first case is a case where the PIC/UAM aerial vehicle 152 intentionally does not comply with UAM regulations due to any other reason, and the second case is the unintentional non-compliance with the UAM operating procedures due to contingencies.

In the first case, it may be assumed that the case where the UAM aerial vehicle 311 intentionally (or systematically) does not comply with the planned UAM operating regulations is the case where the UAM aerial vehicle 311 does not comply with the planned flight operation due to airframe performance problems, strong winds, navigation failure, etc.

However, in the first case, the PIC/UAM aerial vehicle 152 may be in a state in which it may safely arrive at the planned aerodrome 310 within the flight corridor 300.

When the PSU 102 identifies that the off-nominal operation according to the first case has occurred in the PIC/UAM aerial vehicle 152, the PSU 102 distributes, to each stakeholder (UAM operator 154, USS 104, vertiport operator 202, UTM ecosystem 230, ATM operators 204, etc.) through a wired/wireless network, PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the UAM operator 154 and the PSU 102 receiving the PIC/UAM aerial vehicle off-nominal event occurrence information may generate a new UAM operation plan that may satisfy UAM community based rules (CBR) and performance requirements for operation within the flight corridor 300, and distribute the generated new UAM operation plan to stakeholders again.

In the second case, the case where the UAM aerial vehicle 152 unintentionally does not comply with the UAM operation due to an accidental situation may be a state in which the forced landing (crash landing) of the UAM aerial vehicle 152 is required, and may be a severe situation where the planned flight operation may not be performed.

That is, the second case is the case where, since it is difficult for the PIC/UAM aerial vehicle 152 to safely fly to the planned aerodrome 310 within the flight corridor 300 assigned thereto, the PIC/UAM aerial vehicle 152 may not fly within the flight corridor 300 assigned thereto.

When the off-nominal operation according to the second case has occurred, similar to the first case, the PSU 102 distributes, to each stakeholder (UAM operator 154, USS 104, vertiport operator 202, UTM ecosystem 230, ATM operators 204, etc.) through the wired/wireless network, the PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the PIC/UAM aerial vehicle 152 is reassigned a new flight corridor 300 for flight to a previously secured landing spot and a track identifier within the flight corridor 300 in preparation for an emergency situation in the UAM aerial vehicle, and at the same time, may fly in a flight mode to avoid collision damage with other aerial vehicles through communication means (ADS-B, etc.).

Hereinafter, an evaluation indicator for the operation of the UAM aerial vehicle according to an embodiment of the present disclosure will be described.

As shown in <Table 1> below, UAM operational evaluation indicators may include major indicators such as operation tempo, UAM structure (airspace and procedures), UAM regulatory changes, UAM community regulations (CBR), aircraft automation level, etc.

TABLE 1

| Indicator Item | Description |
|---|---|
| Operation Tempo | It indicates density of UAM operation, |
| | frequency of UAM operation, and |
| | complexity of UAM operation. |
| UAM Operation | It indicates complex level of |
| Structure | infrastructure and services supporting |
| (Airspace and | UAM operating environment. |
| Procedure) | |
| UAM Operation | It indicates level of evolution of |
| Regulation | current regulations required for UAM |
| | operation structure and performance. |
| UAM Community | It indicates rules supplementing UAM |
| Laws and Regulations | operation regulations for UAM |
| | operation and expansion of PSU. |
| Aircraft Automation | It may be divided into HWTL (Human- |
| Level | Within-The-Loop), HOTL (Human-On-The- |
| | Loop), HOVTL (Human-Over-The-Loop). |
| | 1) HWTL: Stage where person directly |
| | controls UAM system |
| | 2) HOTL: Stage of system that is |
| | i.e., stage in which human actively |
| | monitors |
| | 3) HOVTL: Stage in which human |
| | controlled under human supervision, |
| | performs monitoring passively |

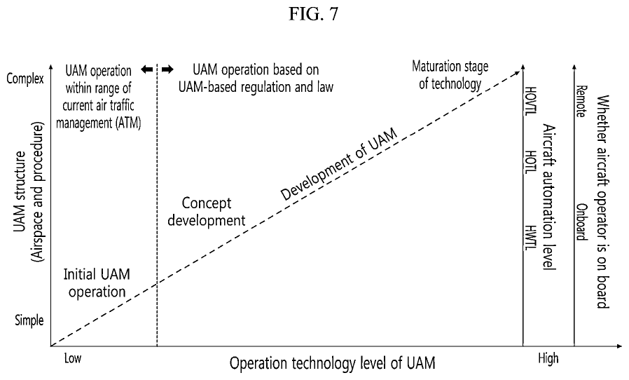

FIG. 7 is a diagram illustrating a development stage of an operating technology level of the UAM.

Hereinafter, concepts of an initial UAM operation stage, a transitional UAM operation stage, and a final UAM operation stage will be described with reference to the above-described key indicators and FIG. 7.

First, in the initial UAM operation stage, the structure of the UAM aerial vehicle is likely to use various existing vertical take-off and landing (VTOL) rotary-wing aircraft infrastructures.

The UAM's regulatory changes may be gradually implemented while complying with aviation regulations and the like under current laws and regulations. However, the UAM community rules (CBR) may not be separately defined.

The aircraft automation level borrows manned rotary-wing technology, which is currently widely used as of the time this specification is written, but an on-board status may be applied to the pilot in command (PIC) stage.

Next, looking at the transitional UAM operation step, in the UAM structure, the UAM airframe may be operated within a specific airspace based on the performance and requirements of the UAM aerial vehicle.

As for UAM regulations, the ATM regulations may be changed and applied, new regulations for UAM that can be operated may be defined, and the UAM community regulations may also be defined.

In the transitional UAM operation stage, the automation level of the UAM aerial vehicle may be capable of PIC control with an airframe designed exclusively for the UAM, but the on-board status may still be maintained as the PIC stage.

Finally, looking at the final UAM operation stage, the UAM airframe may be operated in a specific airspace based on the performance and requirements of the UAM aerial vehicle, but several variables may exist.

It is predicted that the UAM regulation changes will require additional regulations to enable various operations within the UAM flight corridor, and as the complexity of the UAM community regulations increases, FAA guidelines are expected to increase.

Due to the development of artificial intelligence (AI) technology and the development of aviation airframe technology, the aircraft automation level will be realized at a higher automation level compared to the UAM aerial vehicle at the existing stage. As a result, it is predicted that it will reach the unmanned horizontal or vertical take-off or landing technology level, and the PIC stage may be a stage where remote control is possible.

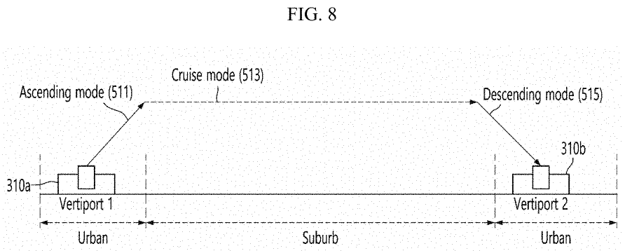

FIG. 8 is a diagram for describing a flight mode of the UAM aerial vehicle according to an exemplary embodiment of the present disclosure.

Referring to FIG. 8, in an embodiment of the present disclosure, the flight mode of the UAM aerial vehicle may include a take-off mode (not illustrated), an ascending mode 511, a cruise mode 513, a descending mode 515, and a landing mode (not illustrated).

The take-off mode is a mode in which the UAM aerial vehicle takes off from a vertiport 310a at the starting point, the ascending mode 511 is a mode in which the UAM aerial vehicle performs a stage of ascending the flight altitude step by step to enter the cruise altitude, the cruise mode 513 is a mode in which the UAM aerial vehicle flies along the cruise altitude, the descending mode 515 is a mode in which the UAM aerial vehicle performs a stage of descending the altitude step by step in order to land from the cruise altitude to the vertiport 310b of the destination, and the landing stage is a mode in which the UAM aerial vehicle lands on the vertiport 310b of the destination.

In addition, in the take-off mode, the UAM aerial vehicle may perform a taxiing stage to enter the vertiport 310a of the departure point, and even after the landing stage, the UAM aerial vehicle may perform the taxiing stage to enter the vertiport 310b of the destination.

In another embodiment of the present embodiment, in the case of the vertical take-off and landing (VTOL), a take-off mode and the ascending mode 511 may be performed simultaneously, and a landing mode and descending mode 515 may also be performed simultaneously.

In this embodiment, the UAM aerial vehicle is a type of urban transport air transportation means, and the vertiport 310a of the departure point and the vertiport 310b of the destination may be located in the urban area, and according to the cruise mode 513, the aviation corridor on which the UAM aerial vehicle flies may be located in the suburban area outside the urban area.

According to the above-described embodiment of the present disclosure, the take-off mode, the ascending mode 511, the descending mode 515, and the landing mode of the UAM aerial vehicle are performed in a densely populated urban area so thrust may be generated through a distributed electric propulsion (DEP) method to suppress the generation of soot and noise caused by an internal combustion engine.

On the other hand, in the cruise mode 513 of the UAM aerial vehicle, which is mainly performed in the suburban area, the thrust may be generated by an internal combustion engine (ICE) propulsion method in order to increase an operating range, a payload, a flying time, etc.

Of course, the propulsion method for generating the thrust of the UAM aerial vehicle is not necessarily determined for each flight mode described above, and the thrust of the UAM aerial vehicle may be selected by either the DEP method or the ICE method by additionally considering various factors such as the location, altitude, speed, status, and weight of the UAM aerial vehicle.

The operation of the propulsion system according to the flight area of the UAM aerial vehicle according to the embodiment of the present disclosure illustrated in FIG. 8 is summarized in <Table 2> below.

TABLE 2

| Flight Area | Description of propulsion system operation-control |
|---|---|
| Urban | Generate lift and thrust only with battery, not |
| | internal combustion engines, in consideration of low |
| | noise and eco-friendliness |
| | Flight by selecting propulsion unit that may |
| | generate thrust/lift as much as data trained in |
| | advance through machine learning (ML) rather than full |
| | propulsion system, and generating lift/thrust with |
| | only selected propulsion unit |
| Suburb | In suburban area, which is less sensitive to noise |
| | and eco-friendliness than in urban area, thrust is |
| | generated through all propulsion units to enable full |
| | power flight for cruise flight, and power is supplied |
| | through battery or internal combustion engine |

Meanwhile, in the flight stage including the above-described take-off stage, ascending stage, cruise stage, descending stage, and landing stage, the aerial vehicle may display an augmented reality guidance screen for aerial vehicle passengers including a pilot, passengers, and the like. Hereinafter, a method for providing augmented reality guidance according to an embodiment of the present disclosure will be described in more detail.

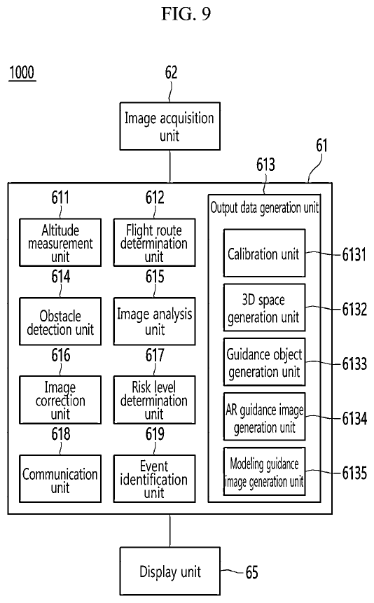

FIG. 9 is a block diagram illustrating a component of an apparatus for assisting landing of an aerial vehicle according to an embodiment of the present disclosure. Referring to FIG. 9, a landing assistance apparatus 1000 may include all or part of an image acquisition unit 62, a data processing unit 61, and a display unit 65.

The image acquisition unit 62 may acquire a flight image of aerial vehicle captured through a camera installed in the aerial vehicle. Here, the flight image of the aerial vehicle may be a concept that includes all images captured by a camera during the entire flight stage of the aerial vehicle, including the take-off stage, ascending stage, cruise stage, descending stage, and landing stage of the aerial vehicle.

The camera may be provided at a location where it does not interfere with the body of the aerial vehicle or a component providing lift in blades. A plurality of cameras may be provided. In addition, in the case of the camera installed under the aerial vehicle among the plurality of cameras, the camera can be used as an AR landing aid when the aerial vehicle lands.

The camera may be provided to be tiltable. More specifically, the camera may be rotatably provided to correspond to an attitude control (roll, pitch, yaw) of the aerial vehicle. As the camera rotates in response to the attitude control of the aerial vehicle, an angle of view of the image acquired through the camera may be guaranteed, so that an image in a certain direction may be obtained independently of the attitude control of the aerial vehicle.

The data processing unit 61 may process various data collected in the overall flight stage of the aerial vehicle, including the take-off stage, ascending stage, cruise stage, descending stage, and landing stage of the aerial vehicle, and perform the control functions of each module.

Here, the data processing unit 61 includes all or part of an altitude measurement unit 611, a flight route determination unit 612, an output data generation unit 613, a static obstacle detection unit 614, an image analysis unit 615, an image correction unit 616, a risk level determination unit 617, a communication unit 618, and an event identification unit 619.

The image analysis unit 615 may perform analysis on the aerial vehicle flight image acquired by the image acquisition unit 62. Specifically, the image analysis unit 615 may analyze a landing image of the aerial vehicle among images acquired by the image acquisition unit 62 to detect a landing area or recognize a landing marker provided in a vertiport.

Here, the vertiport may include various facilities for taking off and landing of the aerial vehicle, and the landing area of the aerial vehicle may refer to a point where the aerial vehicle actually lands among various facilities included in the vertiport.

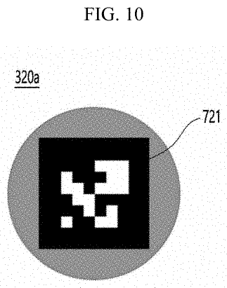

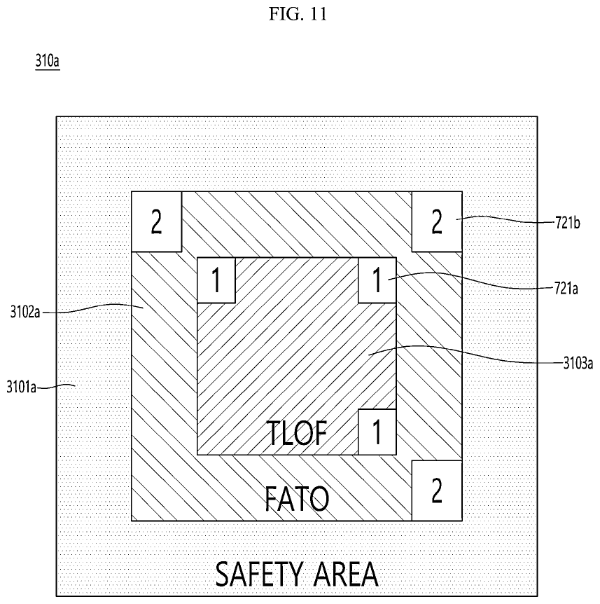

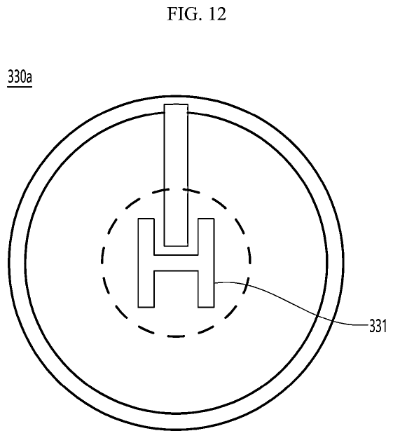

This landing area may be implemented in a form including a digital landing marker 721 as illustrated in FIGS. 10 and 11, or may be implemented in a form not including a digital landing marker 721 as illustrated in FIG. 12. This will be described in detail with reference to FIGS. 10 to 12.

Here, the digital landing marker 721 is an artificial landmark made in a certain format, and may include a 2D bit pattern of n*n size and a black border area surrounding the 2D bit pattern.

Referring to FIG. 10, the landing area 320a may be implemented in a circular shape, and the landing marker 721 may be implemented in a rectangular shape having a diagonal length equal to or shorter than a diameter of the landing area 320a.

That is, according to one embodiment of the present disclosure, as illustrated in FIG. 10, the digital landing marker 721 may be implemented so that the digital landing marker 721 occupies most of the area of the landing area, and according to another implementation example, the landing area 320a and the digital landing marker 721 may have the same area, so the digital landing marker 721 itself may be implemented as the landing area 320a.

In addition, referring to FIG. 11, a vertiport 310a may include a first area 3101a corresponding to touchdown and liftoff (TLOF), a second area 3102a corresponding to final approach and take-off (FATO), and a third area 3103a corresponding to a safety area.

The first area 3101a may refer to a landing area, the second area 3102a may refer to an area where aerial vehicle finishes approach and enters a hovering or landing stage (descending), and a third area 3103a may refer to an area to reduce the risk that may occur due to an off-nominal situation that aerial vehicle is out of the FATO area due to an off-nominal situation during take-off and landing of the aerial vehicle.

In this case, the digital landing marker of the pattern illustrated in FIG. 11 may be provided on at least a part 721a of edges of the first area 3101a to indicate the range of the first area 3101a. In addition, the digital landing marker of the pattern illustrated in FIG. 11 may be provided on at least a part 721b of edges of the second area 3102a to indicate the range of the second area 3102a.

Meanwhile, since the first area 3101a has a smaller area than the second area 3102a, the digital landing marker 721a provided in the first area 3101a may have a relatively smaller size than the digital landing marker 721b provided in the second area 3102a.

Meanwhile, the image analysis unit 615 to be described later may detect or recognize a relatively large third area 3103a at a higher altitude as the markers 721a and 721b, detect or recognize the second area 3102a, and detect or recognize the first area 3101a. Therefore, it may be effective to sequentially detect or recognize each area when the marker 721b provided in the second area has a relatively larger size than the marker 721a provided in the first area.

Meanwhile, the digital landing markers 721, 721a, and 721b (hereinafter referred to as 721) illustrated in FIGS. 10 and 11 may be used to calculate the location and direction of the aerial vehicle in a 3D space so that the aerial vehicle may land safely.

Specifically, the image analysis unit 615 may detect the digital landing marker 721 from the landing image of the aerial vehicle among the images acquired by the image acquisition unit 62, calculate the coordinates of the corners of the detected digital landing marker 721, and estimate the 3D attitude of the digital landing marker 721 based on the camera coordinate system using the calculated corner coordinates (here, corner coordinates may be coordinates of the four vertices of the marker 721) and the camera calibration. In addition, the image analysis unit 615 may calculate the location and direction of the aerial vehicle in the 3D space by estimating the attitude of the aerial vehicle based on the 3D attitude of the digital landing marker 721 based on the estimated camera coordinate system.

According to one implementation example, the image analysis unit 615 may recognize the landing marker by performing image processing on the captured landing marker image using an artificial neural network model. Specifically, the image analysis unit 615 may recognize the landing marker by estimating a non-recognized part using the trained artificial neural network model when only part of the landing marker is recognized by the surrounding objects or obstacles.

In addition, when using the digital landing marker 721 of FIGS. 10 and 11, the image analysis unit 615 may be implemented to calculate all the matching degree, the location of the aerial vehicle, and the direction of the aerial vehicle of FIG. 12 to be described later.

On the other hand, FIG. 12 illustrates a typical form of aerial vehicle landing area. Referring to FIG. 12, a landing area 330a may not include the digital landing marker 721 illustrated in FIGS. 10 and 11, and include only a non-digital landing marker 331 that a pilot may see with the eyes.

When the vertiport does not include the digital landing marker 721 as illustrated in FIG. 12, the image analysis unit 615 may calculate the matching degree of “aerial vehicle landing guide object” fixed and set to the default location on the screen for the pilot's landing assistance and the “landing area” detected in the landing image of the aerial vehicle among the images acquired from the image acquisition unit 62. In addition, the image analysis unit 615 may calculate the location and direction of the aerial vehicle in the 3D space based on the calculated matching diagram.

Meanwhile, the location and direction of the aerial vehicle in the matching degree and/or 3D space calculated by the image analysis unit 615 may be used as parameters to generate the landing guide object assisting the landing of the aerial vehicle displayed on the display unit 65 in the output data generation unit 613. For example, when it is determined that the aerial vehicle is landing properly since the calculated matching degree is high, the display unit 65 may display the landing guide object indicating “normal landing”, and when it is determined that the aerial vehicle not landing properly since the calculated matching degree is low, the display unit 65 may display the landing guide object indicating “off-nominal landing”.

Meanwhile, the image correction unit 616 may perform image stabilization on the aerial vehicle flight image acquired by the image acquisition unit 62. For example, the image correction unit 616 may use an OIS method of performing image stabilization in hardware using a gyro sensor, an EIS method of performing image stabilization by cropping a central region of an image using a gyro sensor, etc., to perform the correction of the aerial vehicle flight image acquired by the image acquisition unit 62.

The communication unit 618 is a module for a communication function of the augmented reality providing apparatus 1000, and the communication unit 618 may receive information transmitted from a control unit or a base station. Here, examples of the information transmitted from the control unit and the base station may include weather information of a flight zone, information of a prohibited area, flight information of other aerial vehicles, map data, and the like. Among the information received through the communication unit 618, information directly or indirectly affecting the flight route of the aerial vehicle may be displayed through the display unit 65.

The altitude measurement unit 611 may measure the altitude of the aerial vehicle. Here, the altitude of the aerial vehicle measured by the altitude measurement unit 611 may be used to perform determining whether aerial vehicle is flying through flight corridors, calculate an altitude of the aerial vehicle during landing, calculate a relative location of the aerial vehicle and the obstacle detected by the obstacle detection units 614 and 615, determine a designated altitude and/or route deviation, etc., by being used along with a flight route calculated by the flight route determination unit 612.

When the aerial vehicle departs from the designated altitude or leaves the safe altitude and approaches the limit of the designated altitude, a guidance object generation unit 6133, which will be described later, may generate an altitude danger guidance object.

The obstacle detection unit 614 may detect dynamic obstacles and static obstacles. Obstacles or risk factors may be divided into static obstacles defined as regions, buildings, etc., dynamic obstacles defined as mobile objects, and others.

The map data may include dynamic map data that is updated in real time by reflecting pre-constructed static map data and dynamic obstacle information.

The obstacle detection unit 614 may detect static obstacles using static obstacle information included in the pre-constructed static map data or may detect static obstacles by analyzing an image acquired by the image acquisition unit 62.

The obstacle detection unit 614 may detect a dynamic obstacle using dynamic obstacle information included in the dynamic map data, or may detect a dynamic obstacle by analyzing an image acquired by the image acquisition unit 62.

The risk level determination unit 617 may determine the risk of the flight route of the aerial vehicle. For example, the risk level determination unit 617 may determine the risk of the flight route through a distance, a speed, or the like between the obstacle and the aerial vehicle.

In addition, the risk level determination unit 617 may determine the risk level by applying a weight to the hazard information. Here, the calculated risk level may be used as a standard parameter for displaying a guidance object differently.

The flight route determination unit 612 may generate a route for flight to the destination of the aerial vehicle based on the above-described map data, and the flight route determination unit 612 may determine whether the aerial vehicle has deviated from the generated flight route. The flight route may include all flight of the aerial vehicle in the flight plan including take-off, ascending, flight, descending, landing, and taxiing of the aerial vehicle.

The event identification unit 619 may identify the event from the detection result of the obstacle detection unit 614, or detect the event from the aerial vehicle's flight image during the aerial vehicle flight to identify the type of event. An event guidance object indicating the event may be displayed on a guidance image through the display unit 65 according to the identified type of events. Here, the event may include at least one of a bird flock event, a collision risk building, a vertiport, and a prohibited area.

The output data generation unit 613 may generate display data to be displayed through the display unit 65 and/or voice data to be output through a speaker (not illustrated). In particular, the output data generation unit 613 may perform an image rendering process for image display. The output data generation unit 613 may include all or part of a calibration unit 6131, a 3D space generation unit 6132, a guidance object generation unit 6133, an AR guidance image generation unit 6134, and a modeling guidance image generation unit 6135. In particular, in order to display the augmented reality image, the output data generation unit 613 may use all or part of component modules.

The calibration unit 6131 may perform calibration for estimating camera parameters corresponding to the camera from the photographed image photographed in the camera. Here, the camera parameters, which are parameters configuring a camera matrix, which is information indicating a relationship between a real space and a photograph, may include camera extrinsic parameters and camera intrinsic parameters.

The 3D space generation unit 6132 may generate a virtual 3D space on the basis of the photographed image photographed in the camera. In detail, the 3D space generation unit 6132 may generate the virtual 3D space by applying the camera parameters estimated by the calibration unit 6131 to a 2D photographed image.

The guidance object generation unit 6133 may generate an object for various types of guidance, for example, a route guidance object, or the like during the flight of the aerial vehicle. For example, the guidance object generation unit 6133 may generate the route guidance object based on a flight route for flight to a destination of aerial vehicle generated by the flight route determination unit 612. In other examples, the guidance object generation unit 6133 may generate the landing guide object for assisting the landing of the aerial vehicle based on the location and direction of the aerial vehicle in the matching degree and/or the 3D space calculated by the image analysis unit 615.

Here, the guidance object generated by the guidance object generation unit 6133 may be an object displayed in the augmented real guidance image and/or modeling guidance image to be described layer.

The AR guidance image generation unit 6134 may generate an AR guidance image by mapping the guidance object generated by the guidance object generation unit 6133 to an aerial vehicle flight image.

Here, the AR guidance image may include a head up display (HUD)-type AR guidance image that displays an AR guidance object on a forward image transmitted through a windshield of an aerial vehicle and is shown to passengers.

For example, the AR guidance image generation unit 6134 may determine a projection location of the AR guidance object on the windshield by determining the mapping location of the object between virtual 3D spaces in the 3D space generation unit 6132. As a result, it is possible to generate the AR guidance image.

In addition, the AR guidance image may include an AR guidance image of a screen display method displaying an AR guidance object on a captured aerial vehicle flight image shown to a passenger through a screen.

For example, the AR guidance image generation unit 6134 may determine the mapping location of the object in the virtual 3D space in the 3D space generation unit 6132 and generate a 2D image corresponding to the virtual 3D space to which the object is mapped, thereby generating the AR guidance image.

The modeling guidance image generation unit 6135 may generate the modeling guidance image by combining the guidance object generated by the guidance object generation unit 6133 with the 2D or 3D modeling image.

Meanwhile, the display unit 65 may display the guidance image generated by the output data generation unit 613. For example, the display unit 65 may display an AR guidance image on one screen and a modeling guidance image on the other screen.

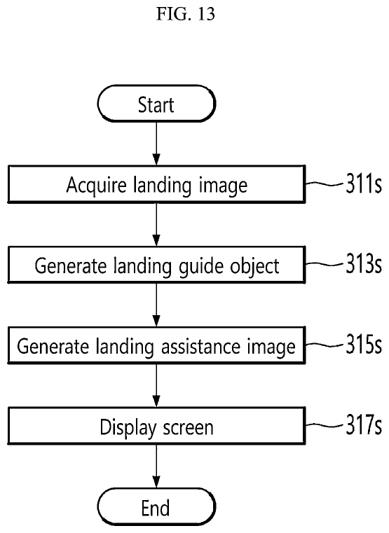

FIG. 13 is a diagram illustrating a method of assisting landing of an aerial vehicle according to an embodiment of the present disclosure. Referring to FIG. 13, the method of assisting landing of an aerial vehicle of this embodiment includes acquiring a landing image (311s), generating a landing guide object (313s), generating a landing assistance image (315s), and displaying the image on the screen (317s).

As described above, the landing image acquiring step (311s) of the image acquisition unit 62 may be a step of obtaining a landing image of the aerial vehicle using a camera provided in the aerial vehicle. The landing image acquiring step (311s) may include correcting the tilt of the camera and correcting image shaking to obtain a flight image of the aerial vehicle in real time.

In the landing image acquiring step (311s), the landing image may be acquired by being captured through the camera installed in the aerial vehicle. When a plurality of cameras are provided, the landing image may be acquired through a camera installed relatively at the lower part of the aerial vehicle, or when a single camera is equipped, the landing image may be acquired through a single camera when the aerial vehicle attempts to land.

In the case of the vertical take-off and landing aerial vehicle (VTOL), the landing attempt of the aerial vehicle may be defined as the landing image from the above-described reference by setting the point at which the altitude of the aerial vehicle is lowered without tilting the blade or body as the landing point. Of course, the timing and method of acquiring the landing image may be variously set through the above configuration, and are not limited to the above method.

The step (313s) of generating the landing guide object of the output data generation unit 613 may be a step of generating a landing guide object that guides the landing of the aerial vehicle. The guidance object generation unit 6133 may generate the landing guide object in various forms by using the matching degree calculated by the image analysis unit 615 and/or the location and direction of the aerial vehicle in the 3D space as parameters.

For example, when the image analysis unit 615 calculates the matching degree of the landing guide object and the landing area detected in the landing image, the guidance object generation unit 6133 may generate the landing guide objects differently according to the calculated matching degree. As an example of generating the landing guide objects differently according to the calculated matching degree, the case in which the matching degree is very low may mean that an aerial vehicle attempts to land in an area deviating from the landing area. In this case, the output data generation unit 613 may generate the landing guide object in red and repeatedly blink the landing guide object to be displayed to the pilot and/or passengers through the display unit 65. In addition, when the matching degree is high, it may mean that the aerial vehicle is attempting to land in the landing area. In this case, the output data generation unit 613 may generate a landing guide object in green and display the landing guide object to the pilot and/or passengers through the display unit 65.

As another example, when the image analysis unit 615 recognizes the digital landing marker provided in the vertiport from the landing image of the aerial vehicle and calculates the location and direction of the aerial vehicle using the recognized digital landing marker, the guidance object generation unit 6133 may generate the landing guide objects differently according to the calculated location and direction.

The landing assistance image generating step (315s) of the output data generation unit 613 may generate various types of landing assistance images by mapping the landing guide object to the aerial vehicle flight image and/or the landing image.

The displaying step (317s) of the display unit 65 may be defined as a step of displaying the landing assistance image generated by the output data generation unit 613 on the display unit 65 as described above.

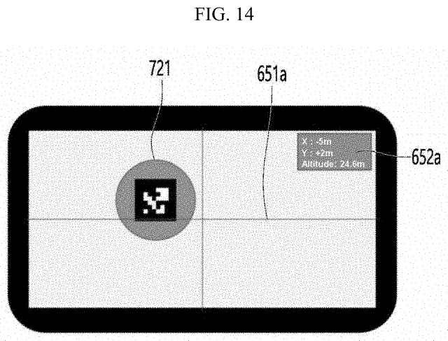

FIGS. 14 to 16 are diagrams illustrating a landing assistance screen displayed on the display unit 65 when the aerial vehicle lands in the landing area illustrated in FIG. 10.

Referring to FIG. 14, the display unit 65 may display a screen assisting the aerial vehicle landing when the pilot lands. The screen may include a landing image including the landing area 320a according to the real-time capturing of the camera, a first landing guide object 651a fixed and displayed as a default location on the screen, a second landing guide object 652a that numerically displays the landing assistance information of the aerial vehicle, and a third landing guide object 653a that guides the pilot's flight direction and distance.

The image analysis unit 615 may recognize the digital landing marker 721 from the landing image acquired through the image acquisition unit 62, and calculate the location and direction of the aerial vehicle using the recognized digital landing marker 721. At the same time, the image analysis unit 615 may calculate the matching degree of the first landing guide object 651a fixedly set and displayed to the default location on the screen to assist the pilot in landing and the landing area 320a detected in the landing image of the aerial vehicle among the images acquired by the image acquisition unit 62.

In this case, the output data generation unit 613 may generate a second landing guide object 652a indicating the deviation distance between the aerial vehicle and the landing area (or digital marker) based on the calculated aerial vehicle location and display the generated second landing guide object 652a on the display unit 65.

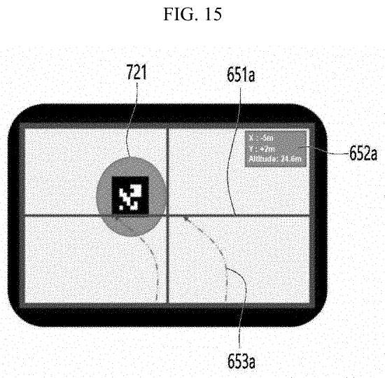

In addition, referring to FIG. 15, when it is determined that the aerial vehicle deviates from the route heading to the landing area based on the matching degree calculated by the image analysis unit 615 and/or the location and direction of the aerial vehicle, the output data generation unit 613 may generate the fixed first landing guide object 651a in red and display the generated first landing guide object 651a on the display unit 65. In addition, the output data generation unit 613 may generate a third landing guide object 653a indicating in which direction a pilot should fly and how much to land based on the calculated location and direction, and display the generated third landing guide object 653a on the display unit 65.

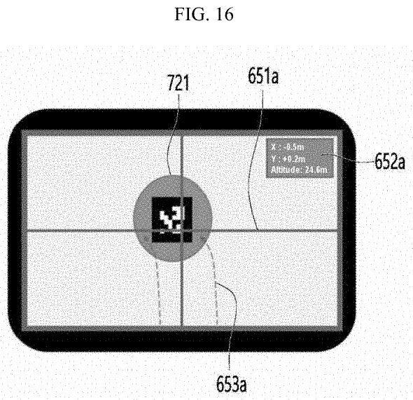

Meanwhile, referring to FIG. 16, when it is determined that the aerial vehicle does not deviate from the route heading to the landing area based on the matching degree calculated by the image analysis unit 615 and/or the location and direction of the aerial vehicle, the output data generation unit 613 may generate the fixed first landing guide object 651a in green and display the generated first landing guide object 651a on the display unit 65. Also, the output data generation unit 613 may generate the third landing guide object 653a indicating that a pilot is landing accurately based on the calculated location and direction, and display the generated third landing guide object 653a on the display unit 65.

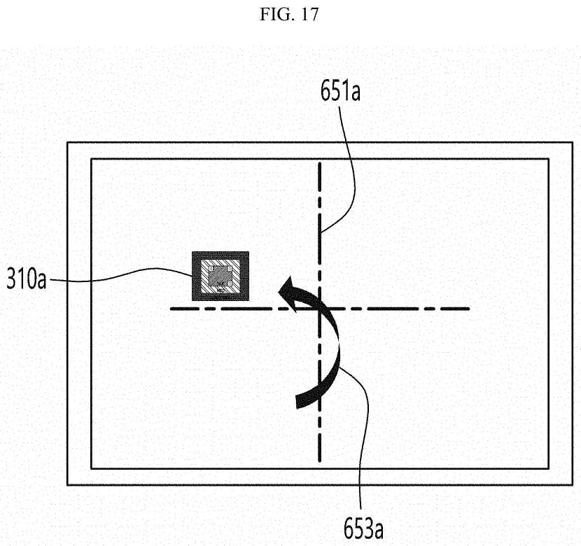

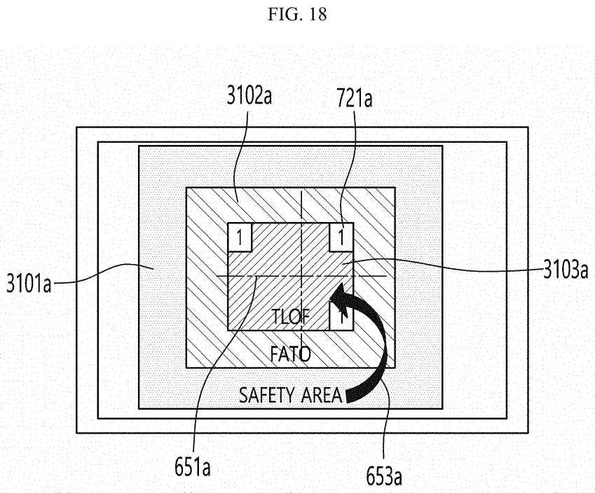

FIGS. 17 and 18 are diagrams illustrating a landing assistance screen displayed on the display unit 65 when the aerial vehicle lands in the landing area illustrated in FIG. 11.

FIG. 17 illustrates a landing assistance screen displayed on the display unit 65 when the aerial vehicle lands at a high altitude, and FIG. 18 illustrates the landing assistance screen displayed on the display unit 65 when the aerial vehicle approaches a vertiport.

Referring to FIGS. 17 and 18, the display unit 65 may display the screen assisting the aerial vehicle landing when the pilot lands. The screen may include a landing image including the landing area 310a according to the real-time capturing of the camera, the first landing guide object 651a displayed fixedly set to a default position on the screen, and the third landing guide object 653a that guides the pilot's flight direction and distance.

In addition, referring to FIG. 11, a vertiport 310a may include a first area 3101a corresponding to touchdown and liftoff (TLOF), a second area 3102a corresponding to final approach and take-off (FATO), and a third area 3103a corresponding to a safety area.

The output data generation unit 613 may include the first landing guide object 651a and the third landing guide object 653a that guide the accurate landing of the aerial vehicle based on the matching degree calculated by the image analysis unit 615 and/or the location and direction of the aerial vehicle.

For example, the output data generation unit 613 may generate the third landing guide object 653a for guiding the aerial vehicle to enter the vertiport landing area 3101a based on the location and direction of the aerial vehicle, and display the generated third landing guide object 653a on the display unit 65. This example may be a display method when the aerial vehicle does not enter a predetermined altitude approaching the ground.

As another example, the output data generation unit 613 may generate the third landing guide object that guides sequential entry into the safety area 3103a, the final approach and take-off (TLOF), and the touchdown and liftoff 3101a and display the generated third landing guide object on the display unit 65. This example may be a display method when the aerial vehicle approaches the ground and enters a predetermined altitude.

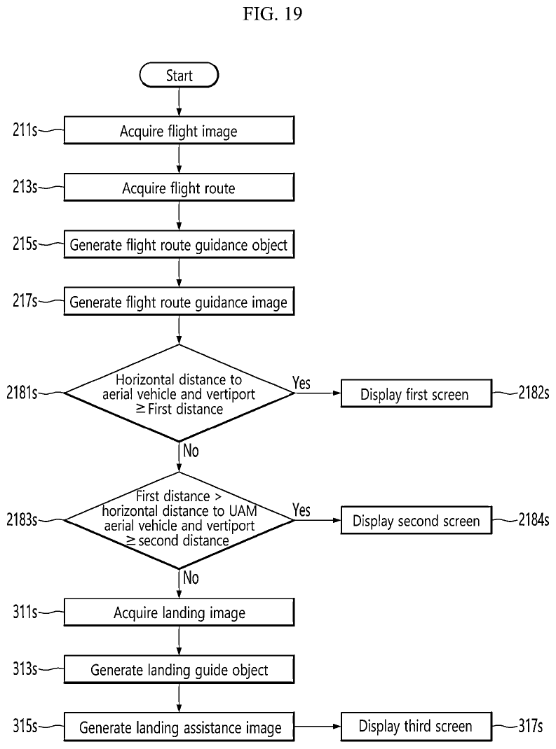

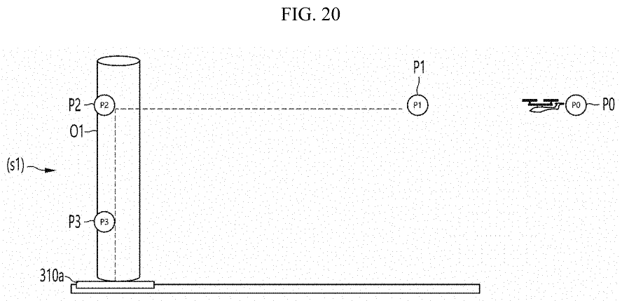

FIG. 19 is a diagram illustrating a method of assisting landing of an aerial vehicle according to another embodiment of the present disclosure, and FIGS. 20 to 22 are diagrams illustrating a landing assistance guidance screen according to an embodiment of the present disclosure.

Referring to FIGS. 19 to 22, the flight image acquiring step (211s) by the image acquisition unit 61 is a step of acquiring a real-time aerial vehicle flight image by correcting the tilt of the camera and performing the image stabilization through the input camera image and sensor data as described above.

The flight route acquiring step (213s) by the flight route determination unit 612 is a step of acquiring the flight route from the departure point of the aerial vehicle to the destination. The flight route may be generated by the flight route determination unit 612, and may include all traveling of the aerial vehicle in the flight plan including take-off, ascending, flight, descending, landing, and ground run of the aerial vehicle.

The route guidance object generating step (215s) by the output data generation unit 613 is a step of generating the route guidance object based on the above-described flight route, and the route guidance object may be generated in various forms by a guidance object generation unit 6133.

For example, in the route guidance object generating step (215s), a route guidance object composed of a plurality of objects is generated, and the route guidance object may be generated by adjusting an arrangement interval of the plurality of objects according to whether the route is a curve route or a straight route.

In the route guidance image generating step (217s), various types of images may be generated by mapping a route guidance object to an aerial vehicle flight image.

For example, the route guidance image further includes an object indicating the yaw, pitch, and inclination in roll direction of the aerial vehicle.

Meanwhile, the image generated in the route guidance image generating step (217s) may be differently displayed on the display unit 65 on the screen according to the horizontal distance to the aerial vehicle and the vertiport.

More specifically, when the horizontal distance to the aerial vehicle and the vertiport determined through the flight route determination unit 612 is equal to or greater than a first distance (2181s: YES), the first screen may be displayed on the display unit 65 (2182s).

For example, as illustrated in FIG. 20, the first distance may refer to a distance far longer than the second distance that defines a horizontal distance P1-P2 from a vertiport 310a to a first point P1. In this case, the output data generation unit 613 may display an object O1 corresponding to the vertiport, objects P1 and P2 at points defining the second distance to be described below, an object P3 at a point where the aerial vehicle can vertically land, and a guidance image S1 including the objects O1, P1, P2, and P3 generated through the display unit 65 (2182s).

On the other hand, when the horizontal distance to the UAM Aerial vehicle and vertiport, which are determined through the flight route determination unit 612, are smaller than the first distance(2181S: NO), the flight route determination unit 612 may determine whether the horizontal distance to the aerial vehicle and the vertiport is greater than a second distance (2183S).

When the horizontal distance between the aerial vehicle and the vertiport is greater than or equal to the second distance and less than the first distance (2183s: YES), the second screen may be displayed on the display unit 65 (2184s).

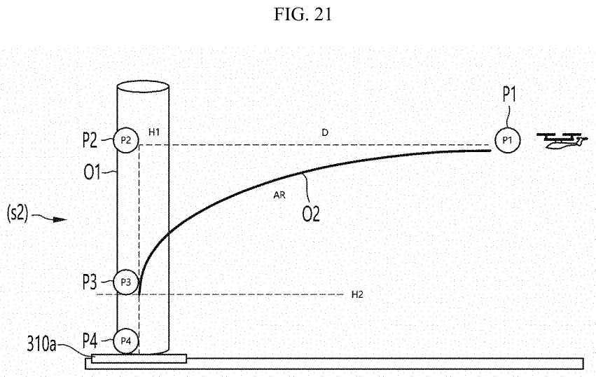

For example, as illustrated in FIG. 21, the second distance may mean a horizontal distance P1-P2 from the landing port 310a to a first point p1. In this case, the output data generation unit 613 may generate an object O1 corresponding to a vertiport, objects P1 and P2 at points defining the second distance, an object P3 at a point where the UAM aerial vehicle may vertically land, an object O2 that guides the vertical landing of the aerial vehicle by connecting the object P1 to the object P3, and an object P4 for guiding vertical landing to the landing port 310a from the object P3, and display the guidance image including the generated objects O1, 02, P1, P2, P3, and P4 on the display unit 65 (2182s).

In this case, the object O1 corresponding to the landing port displayed on an image S2 may be displayed differently from an object O1 corresponding to the landing port displayed on the image S1. For example, the object O1 corresponding to the vertiport displayed in the image S2 may be generated to have higher transparency than the object O1 corresponding to the landing port displayed in the image S1 and displayed on the display unit 65, thereby intuitively guiding the pilot and/or passengers that the UAM aerial vehicle approaches the vertiport 310a.

Meanwhile, when the horizontal distance between the aerial vehicle and the vertiport determined through the flight route determination unit 612 is smaller than the second distance (2183s: NO), the landing image acquiring step (311s) through the image acquisition unit 62, the landing guide object generating step (313s), the landing assistance image generating step, and the third screen displaying step (317s) may be performed. The steps 311s, 313s, and 315s are omitted as described above.

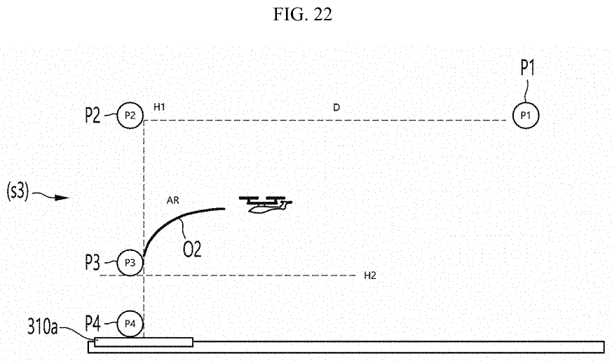

Here, the third screen displaying step (317s) may be defined as a step of displaying the landing assistance image on the display unit 65 as described above. In addition, as illustratively illustrated in FIG. 22, the output data generation unit 613 may generate the objects P1 and P2 at points defining the second distance, the object P3 at a point where the aerial vehicle may land vertically, the object O2 that guides the vertical landing of the UAM aerial vehicle by connecting the object P1 to the object P3, and the object P4 that guides the vertical landing from the object P3 to the landing port 310a, and display the guidance image including the generated objects O1, 02, P1, P2, P3, and P4 through the display unit 65 (2182s).

By omitting the object O1 corresponding to the vertiport created in FIGS. 20 and 21 in the image S3, it is possible to intuitively inform the pilot and/or passengers that the aerial vehicle approaches the vertiport 310a.

In addition, in FIGS. 20 to 22, the display unit 65 may display an object P0 corresponding to the aerial vehicle, through which the pilot and/or passengers may more intuitively confirm the distance and direction between the aerial vehicle and the vertiport.

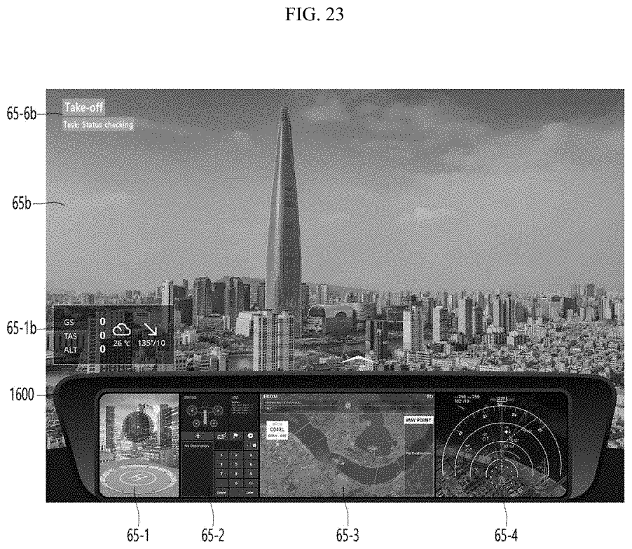

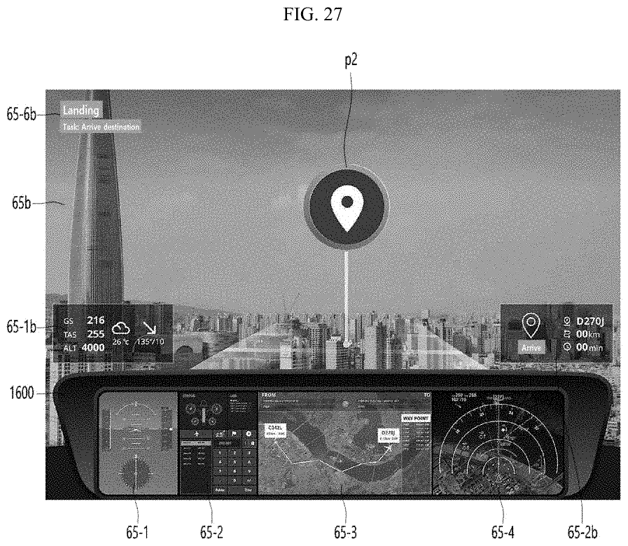

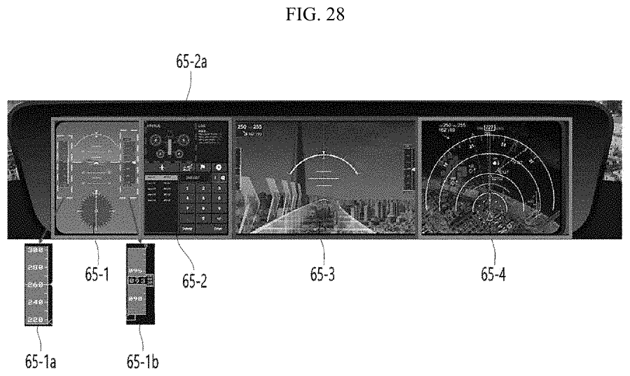

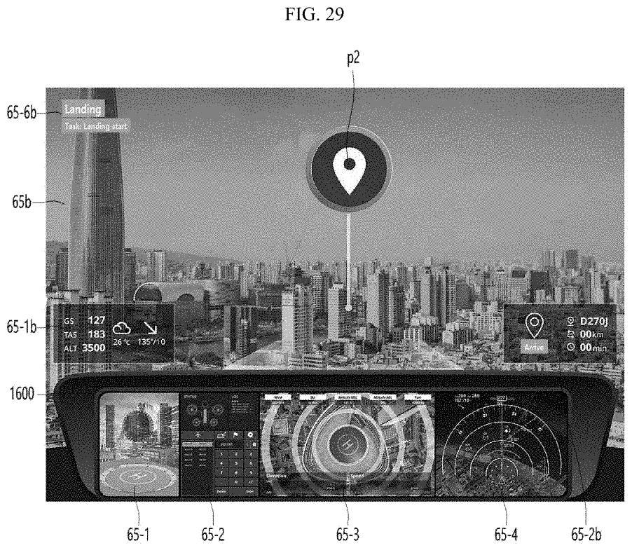

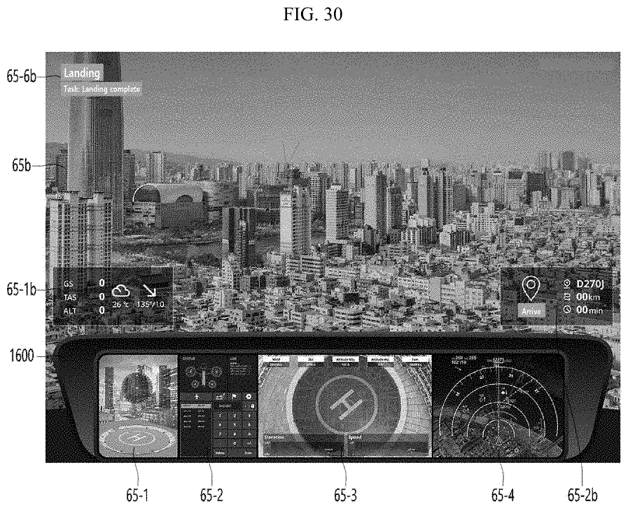

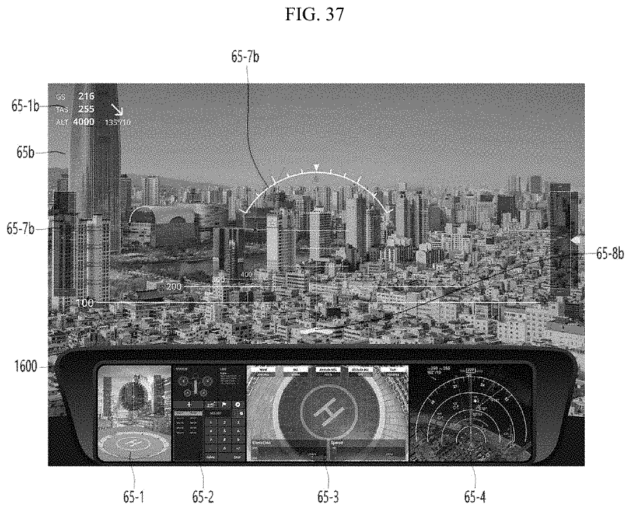

FIGS. 23 to 37 are diagrams illustrating a method of displaying a guidance object for guidance of UAM aerial vehicle according to another embodiment of the present disclosure. More specifically, FIGS. 23 to 27 are diagrams illustrating AR guidance objects displayed during the take-off and landing of the UAM aerial vehicle according to a fourth embodiment of the present disclosure, FIG. 28 is a diagram illustrating a secondary flight display of FIG. 27, and FIGS. 29 and 30 are diagrams illustrating a landing guidance screen of a surround view monitor method according to an embodiment of the present disclosure.

As illustrated in FIGS. 23 to 30, the display of the UAM aerial vehicle may include a primary flight display 65b that is transmitted through the windshield of the UAM aerial vehicle and displays various types of information related to UAM flight to a pilot and/or passengers in the AR form, and a secondary flight display 1600 that displays various types of flight assistance information necessary for the UAM flight to a UAM pilot on a plurality of displays.

A UAM flight assistance information object 65-1b indicating information on weather, wind speed, data processing unit 61, etc., transmitted from the UAM operator 154 and a UAM flight route assistance information object 65-2b indicating information such as the time required to reach the destination, the distance to the destination, etc., measured through the data processing unit 61 may be projected through the display unit 65 and displayed on the primary flight display 65b.

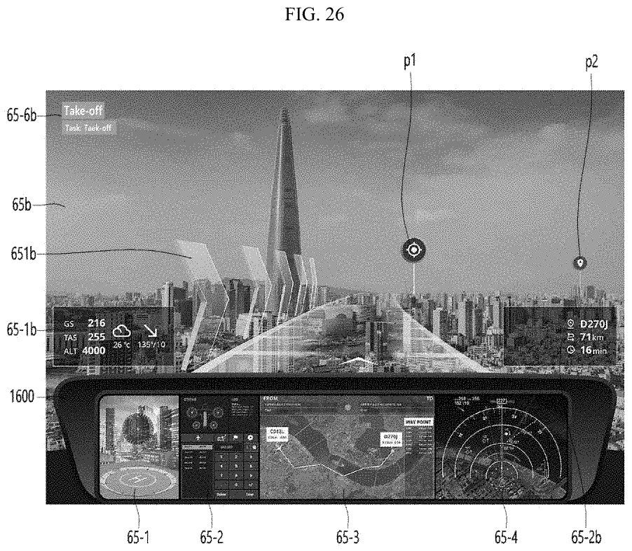

More specifically, referring to FIG. 26, the UAM flight assistance information 65-1b may include a ground speed (GS) indicated by “216”, an altitude (ALT) indicated by “255”, and a true airspeed (TAS) indicated by “4000”, and may further include temperature and weather and wind direction and speed.

The UAM flight route assistance information 65-2b may include a location of a destination indicated by “D270J”, a distance to a destination indicated by “71KM”, an estimated time to a destination indicated by “16 min”, a turn direction, and a distance to a turn point.

In addition, a guidance object (waypoint, p1) indicating a waypoint generated through the output data generation unit 613 and the display unit 65, a guidance object (vertiport, p2) indicating a destination, and an AR route guidance object 65-3b may be displayed on the primary flight display 65b.

In addition, a UAM flight-related event guidance message 65-6b may be displayed on the primary flight display 65b. Here, the UAM flight-related event message 65-6b may include a notification of the current situation of the UAM aerial vehicle indicated as “take-off, flight, landing” and a detected dangerous object indicated as “Task: building occurrence notification”, and the notification of the risk objects will be described later.

Meanwhile, the secondary flight display 1600 may be implemented in the form of a multi-function display (MFD). The secondary flight display 1600 may include a first display 65-1, a second UAM display 65-2, a third display 65-3, and a fourth display 65-4.

The first display 65-1 may display an image for assisting take-off and landing of aerial vehicle, an image for attitude control of UAM aerial vehicle, etc.

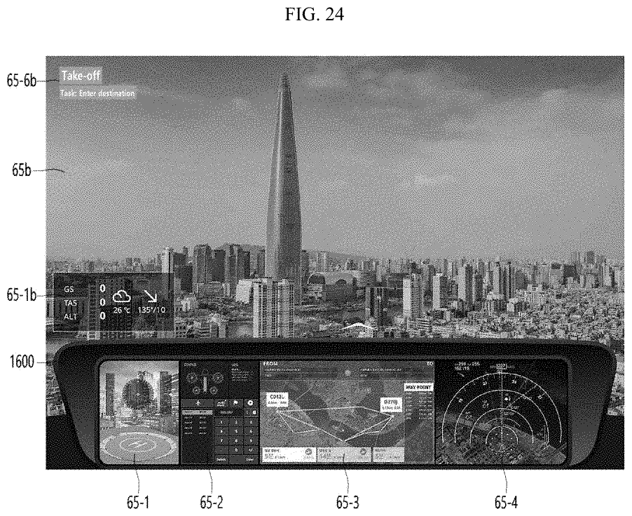

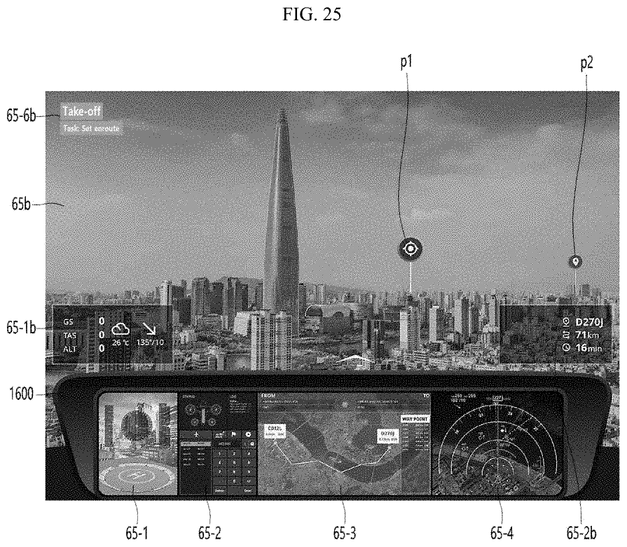

More specifically, in the device status confirming step of the take-off process of FIG. 23, the destination input step of the take-off process of FIG. 24, and the take-off process of FIG. 25, the output data generation unit 613 may generate a take-off assistance guidance image of the UAM aerial vehicle and display the generated take-off assistance guidance image on the first display 65-1. In addition, in the flight process or the destination arrival stage of the landing process of FIG. 27, the output data generation unit 613 may generate an image for attitude control or the like of the UAM aerial vehicle and display the generated image on the first display 65-1. In addition, in the landing start stage of the landing process of FIG. 29 or the landing completion stage of the landing process of FIG. 30, the output data generation unit 613 may generate a landing assistance guide image and display the generated landing assistance guide image on the first display 65-1 and the third display 65-3.

Meanwhile, describing the secondary flight display 1600 with reference to FIG. 28, a UAM electronic attitude direction indicator (EADI) including horizontal lines and vertical lines may be included in the image displayed on the first display 65-1 during the takeoff of the UAM aerial vehicle.

The horizontal lines in the electronic attitude meter may provide the UMA pitch information, the vertical lines may provide the UAM roll information, and when both the UAM's pilot or UAM flight are in autopilot mode, the UAM's flight computer should generate various types of control information to perform the flight according to the provided information.

On the left side of the first display 65-1, a speed indicator 65-1a displaying the current flight speed of the UAM may be displayed overlaid with EADI, and on the right side, a glide scope indicator 65-1b may be displayed overlaid with the EADI.

Meanwhile, the UAM status indicator information may be displayed on the second display 65-2, and exemplarily, the information displayed on the second display 65-2 may include a UAM's propulsion unit status indicator 65f-a.

Reference number 65-2a shows that the number of UAM propulsion units is four, but this only shows a current status of each propulsion unit in real time when the UAM is a quadcopter according to one embodiment, and it is natural that they are displayed differently depending on the number of propulsion units mounted on the UAM.

Meanwhile, a third display 65-3 displays a navigation map according to a route pre-assigned to the UAM. In the present disclosure, the route, waypoint, etc., of the UAM are displayed in an AR method. Through the third display 65-3, the pilot and/or passengers of the UAM may intuitively know that the UAM is flying normally without deviating from a predetermined route.

The UAM surrounding environment information display 65-4 may display surrounding obstacles and/or surrounding terrain, etc., that are sensed through non-vision sensors mounted on the UAM, and even when visibility flight is difficult due to fog or the like, the information for assisting the safe flight of the UAM may be provided.

On the other hand, referring to the display screen of the landing process of the UAM aerial vehicle in FIGS. 29 and 30, the vertiport, the altitude of the UAM flight, the attitude of the aerial vehicle, etc., may be displayed on the first display 65-1 when the UAM lands and on the third display 65-3, a landing guide object fixed to a default location may be displayed on a landing image captured in real time by a camera. In this case, the landing guide object displayed on the third display 65-3 may be displayed differently in color, shape, shape, etc., according to a matching degree calculated by the image analysis unit 615.

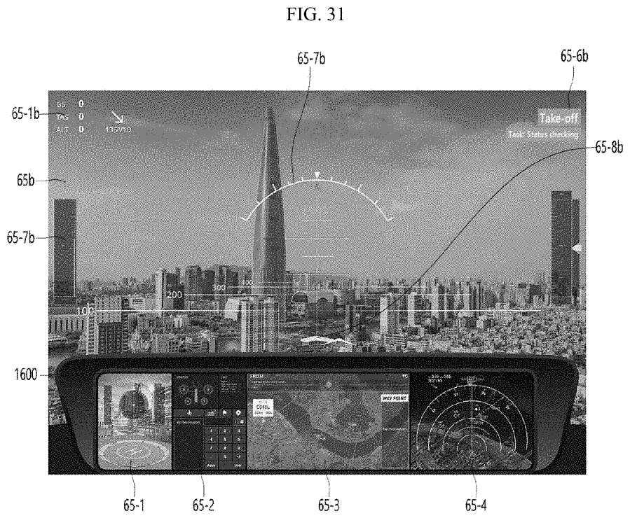

FIGS. 31 to 37 are diagrams illustrating a method of displaying a guidance object for guidance of UAM aerial vehicle according to another embodiment of the present disclosure. Hereinafter, description will be made with reference to FIGS. 31 to 37, but overlapping content with FIGS. 23 to 30 will be omitted.

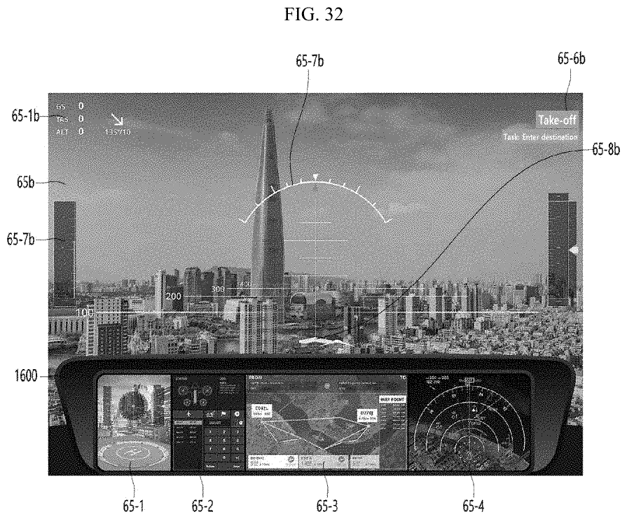

Referring to FIGS. 31 and 32, an object 65-7b indicating information such as horizontal lines, vertical lines, altitude, speed, and glide scope may be displayed on the primary flight display 65b of the UAM aerial vehicle according to another embodiment of the present disclosure. In addition, an object 65-8b indicating the UAM aerial vehicle may be displayed on the primary flight display 65b so that the attitude of the UAM aerial vehicle may be intuitively known through the above-described object 65-7b.

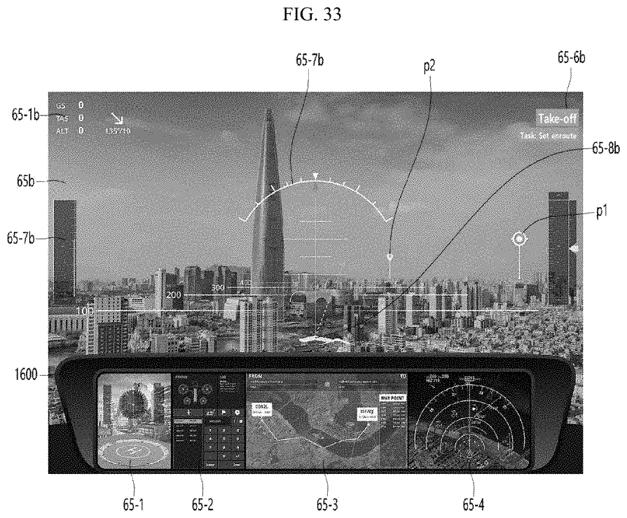

Also, referring to FIG. 33, the primary flight display 65b may further display an object guiding the flight direction of the UAM aerial vehicle to the destination by an arrow.

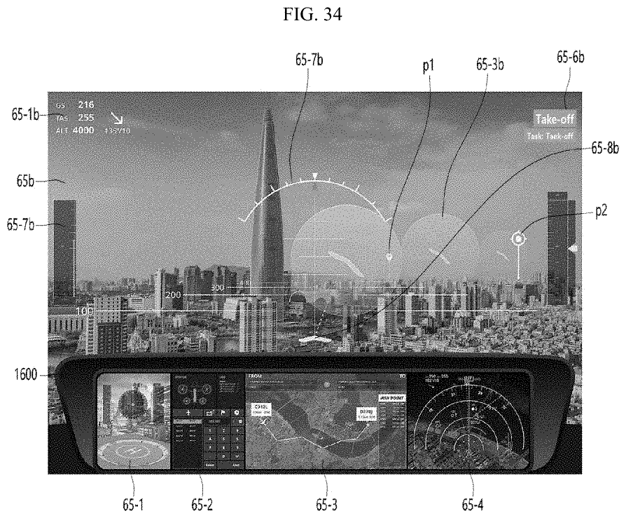

Also, referring to FIG. 34, the primary flight display 65b may display an AR route guidance object 65-3b, but the AR route guidance object 65-3b may be displayed in a circular shape rather than the previously described arrow shape, and the AR route guidance object 65-3b may display a smaller size of the object as the distance from the UAM aerial vehicle increases.

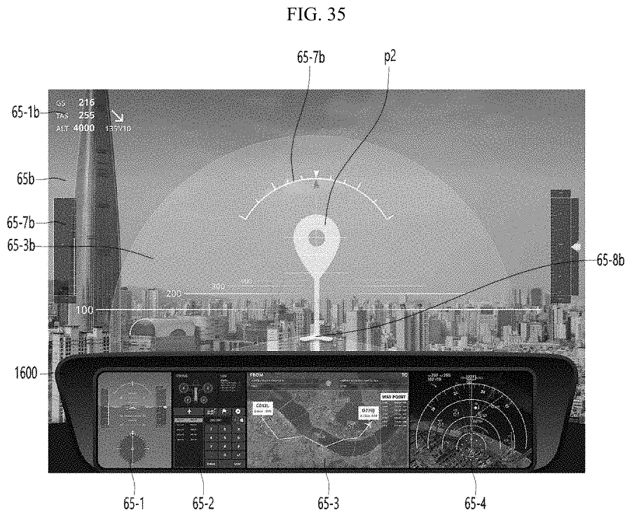

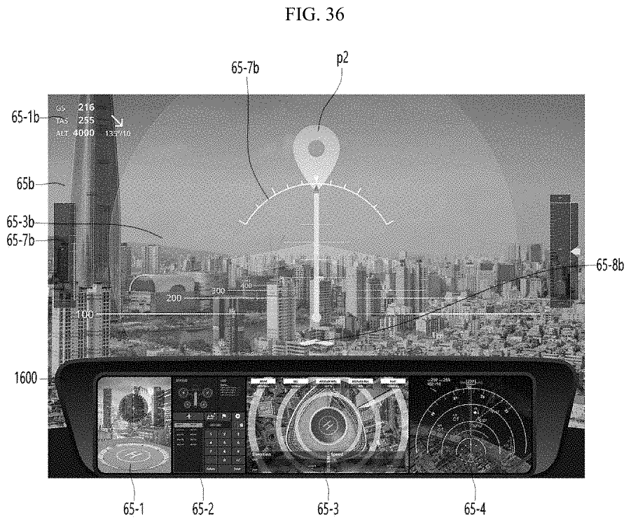

In addition, referring to FIGS. 35 and 36, when the UAM aerial vehicle arrives at the vertiport, the primary flight display 65b may display the object 65-8b indicating the UAM aerial vehicle and the AR route guidance object 65-3b at the same location, thereby intuitively displaying that the UAM aerial vehicle has arrived at the top of the vertiport.

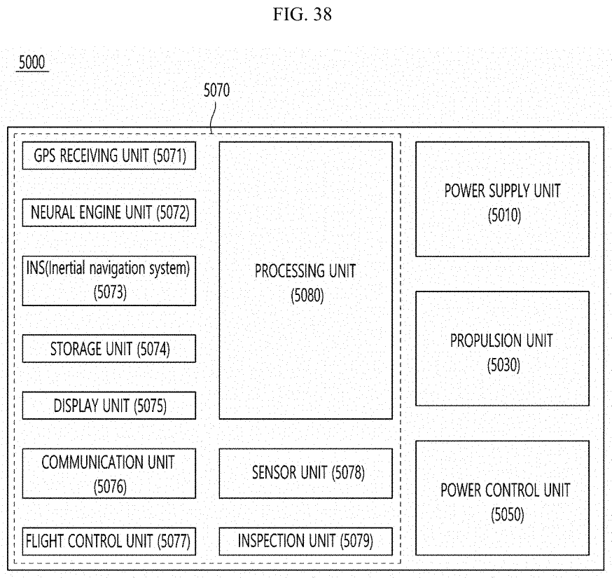

FIG. 38 is a block diagram illustrating UAM aerial vehicle according to an embodiment of the present disclosure. Referring to FIG. 38, a UAM aerial vehicle 5000 may include a power supply unit 5010, a propulsion unit 5030, a power control unit 5050, and a flight control system 5070.

The UAM aerial vehicle 5000 of this embodiment may include a propulsion unit 5030 including a plurality of propulsion units, and a fan module including an electric fan motor and a propeller may be applied as an embodiment of the plurality of propulsion units.

The fan module may receive power through the power supply unit 5010, and control of each of the plurality of fan modules may be performed through the power control unit 5050.

Also, the power control unit 5050 may selectively provide any one of power generated through an internal combustion engine and power generated through electric energy to the plurality of fan modules. More specifically, the power control unit 5050 may include a fuel storage unit, an internal combustion engine, a generation unit, and a battery unit. The fuel storage unit may store fuel required for the operation of the aerial vehicle.

The fuel required for the operation of an aerial vehicle may include taxi fuel required for taxiing on the ground, trip fuel required for one-time landing approach and a missed approach by flying from a departure point to a destination, destination ALT fuel required to fly from the destination to the landing point in case of a nearby emergency, holding fuel required to stay in flight for a certain period of time with the expected weight of the aerial vehicle at the landing point of the destination, additional fuel in case more fuel is required due to a failure of engine, and pressurizer, etc., contingency fuel additionally loading a certain percentage of trip fuel to prepare for an emergency, etc.

The above-described type of fuel is one type for calculating fuel required for the operation of the aerial vehicle, and is not limited to the above-described type, and as will be described later, the amount of fuel stored in the fuel storage unit may be determined by considering the overall energy required for the operation of the aerial vehicle to reach the destination from the departure point together with the battery unit.

The internal combustion engine may generate power to drive a power generation unit by burning fuel stored in the fuel storage unit, and the power generation unit may generate electricity using power generated by the internal combustion engine and provide the power to the propulsion unit 5030.

The battery unit may be charged by receiving power from the power generation unit or by receiving power from the outside.

More specifically, fuel may be stored in the fuel storage unit and power may be supplied to the battery unit to be charged in consideration of total thrust energy required for the aerial vehicle to perform a mission.

However, when it is necessary to charge the battery unit according to the change in flight route due to the off-nominal situation, the battery unit may be charged through the power generation unit as described above.

The power control unit 5050 may include a power supply path control unit, a power management control unit, and a motor control unit, and may be controlled through the flight control system 5070

Here, the flight control system 5070 may receive a pilot's control, a pre-programmed autopilot program, etc., through the control signal of the flight control surface, and control the attitude, route setting, output, etc., of the aerial vehicle.

In addition, the flight control system 5070 may process control and operation of various blocks constituting the UAM aerial vehicle.

The flight control system 5070 may include all or part of a processing unit 5080, a GPS receiving unit 5071, a neural engine unit 5072, an inertial navigation system 5073, a storage unit 5074, a display unit 5075, a communication unit 5076, a flight control unit 5077, a sensor unit 5078, and an inspection unit 5079.

The processing unit 5080 may process various information and data for the operation of the flight control system 5070 and control the overall operation of the flight control system 5070. In particular, the processing unit 5080 may perform the function of the above-described apparatus 1000 for assisting landing of an aerial vehicle, and a detailed description thereof will be omitted.

The aerial vehicle may receive signals from GPS satellites through the GPS receiving unit 5071 to measure the location of the aerial vehicle.

The UAM aerial vehicle 5000 of this embodiment may receive information transmitted from control and base stations through the communication unit 5076. Examples of information transmitted from control and base stations may include weather information of a flight zone, prohibited area information, flight information of other aerial vehicles, etc., and information directly or indirectly affecting the flight route among the information received through the communication unit 5076 may be output through the display unit 5075.

The UAM aerial vehicle 5000 may perform communication with an external control base or other aerial vehicle through the communication unit 5076. For example, the aerial vehicle may perform wireless communication with other UAM aerial vehicle, communication with the UAM operator 154 or the PSU 102, communication with a vertiport management system, and the like through the communication unit 5076.

The storage unit 5074 may store information such as various types of flight information related to the flight of the UAM aerial vehicle, flight plan, flight corridor information assigned from the PSU or UAM operator, track ID information, UAM flight data, and map data. Here, the flight information of the UAM aerial vehicle stored in the storage unit 5074 may exemplarily include location information, altitude information, speed information, flight control surface control signal information, propulsion control signal information, and the like of the aerial vehicle.

In addition, the storage unit 5074 may store a navigation map, traveling information, etc., necessary for the UAM aerial vehicle 5000 to travel from a departure point to a destination.

The neural engine unit 5072 may determine the failure or possibility of failure of each component of the UAM aerial vehicle 5000 through pre-trained data, and the training data may be accumulated through comparison with preset inspection results.

The inspection unit 5079 may compare an inspection result value obtained by inspecting the system of the UAM aerial vehicle 5000 with a preset result value. The above-described comparison may be performed sequentially while matching the components of the power unit and the control surface with the preset result value, and the process or result thereof may be identified to the pilot through the display unit 5075.

The sensor unit 5078 may include an external sensor module and an internal sensor module, and may measure the environment inside and outside the UAM aerial vehicle 5000. For example, the internal sensor module may measure the pressure, the amount of oxygen, etc., inside the UAM aerial vehicle 5000, and the external sensor module may measure the altitude of the UAM aerial vehicle 5000 and the existence of objects around the aerial vehicle, etc.

The inertial navigation system 5073 may use a gyro to create a reference table that maintains a constant attitude in an inertial space and is configured to include a precise accelerometer installed thereon, and may measure the current location of the aerial vehicle by obtaining the flight distance through the acceleration during the operation of the UAM aerial vehicle 5000.

The flight control unit 5077 may control the attitude and thrust of the UAM aerial vehicle 5000. More specifically, the flight control unit 5077 may receive the propulsion power control signal, the flight control surface control signal, etc., from the control surface, the UAM operator 154, the PSU 102, or the like, and control the flight force/control surface of the aerial vehicle.

In addition, the flight control unit 5077 may control the operation of the power control unit 5050. Specifically, the power control unit 5050 may include a power supply path control unit, a power management control unit, and a motor control unit, and the power supply path control unit may select at least one of the power generation unit and the battery unit to supply power to at least one of the plurality of fan modules.

As an example of supplying power to a plurality of fan modules, the power supply path control unit may select at least one of the power generation unit or the battery unit as a power supply source based on the power required to generate the thrust of the aerial vehicle, and then may be controlled to have the same RPM through RPM monitoring of the fan/propeller of the propulsion unit for generating the thrust.

In this case, the power supply control unit may monitor the status of the selected propulsion unit, determine whether there is an inoperative propulsion unit when an error occurs in any one of the selected at least one propulsion unit, and supply power by selecting the inoperative propulsion unit as an alternative propulsion unit when there is the inoperative propulsion unit.

In addition, when there is no inoperative propulsion unit, the power supply path control unit 651 may determine whether insufficient propulsion force can be offset by increasing the RPM of the propulsion unit 631 in normal operation, and if the offset is possible, the insufficient thrust can be supplemented by controlling the propulsion unit in the normal operation, and if offset is not possible, an emergency landing procedure can be performed.

The power management control unit may calculate thrust, power, energy, etc. required for the aerial vehicle to perform a mission, and determine power required for the power generation unit and the battery unit based on the calculated thrust, power, energy, etc.

The motor control unit may control lift, thrust, etc., provided to the aerial vehicle by controlling the fan module.

Meanwhile, the display unit 5075 may display the above-described various landing assistance guidance screens like the display unit 65 of the apparatus 1000 for assisting landing of an aerial vehicle described above.

Hereinabove, the present disclosure has been described with reference to exemplary embodiments. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure.

Therefore, exemplary embodiments disclosed herein should be considered in an illustrative aspect rather than a restrictive aspect. The scope of the present disclosure should be defined by the claims rather than the above-mentioned description, and equivalents to the claims should be interpreted to fall within the present disclosure.

Meanwhile, the methods according to various exemplary embodiments of the present disclosure described above may be implemented as programs and be provided to servers or devices. Therefore, the respective apparatuses may access the servers or the devices in which the programs are stored to download the programs.

In addition, the methods according to various exemplary embodiments of the present disclosure described above may be implemented as programs and be provided in a state in which it is stored in various non-transitory computer-readable media. The non-transitory computer-readable medium is not a medium that stores data therein for a while, such as a register, a cache, a memory, or the like, but means a medium that semi-permanently stores data therein and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

According to various embodiments of the present disclosure, it is possible to safely land the UAM by assisting a pilot during UAM landing.

In addition, according to various embodiments of the present disclosure, it is possible to provide an accurate image to a pilot through image stabilization.

In addition, according to various embodiments of the present disclosure, it is possible to control speed by knowing not only an altitude but also a relative distance between a landing pad and UAM.

In addition, according to various embodiments of the present disclosure, it is possible to perform a safe landing by receiving landing speed guidance through location estimation through a marker.

In addition, according to various embodiments of the present disclosure, it is possible to perform assistance based on a global positioning system (GPS) even in bad weather in which marker recognition is not possible.

The effects of the present disclosure are not limited to the above-mentioned effects, and other effects that are not mentioned may be obviously understood by those skilled in the art from the following description.

Although the exemplary embodiments of the present disclosure have been illustrated and described hereinabove, the present disclosure is not limited to the specific exemplary embodiments described above, but may be variously modified by those skilled in the art to which the present disclosure pertains without departing from the scope and spirit of the disclosure as claimed in the claims. These modifications should also be understood to fall within the technical spirit and scope of the present disclosure.

1. A method of assisting landing of an aerial vehicle based on an image, comprising:
acquiring an aerial vehicle landing image captured by a camera installed on the aerial vehicle;
generating a landing guide object for guiding the landing of the aerial vehicle;
generating a landing assistance image obtained by combining the acquired aerial vehicle landing image and the landing guide object; and
displaying the generated landing assistance image.

2. The method of claim 1, wherein the detecting of the landing area from the landing image includes:
calculating a matching degree between the landing guide object and the detected landing area; and
controlling the landing guide objects to be differently displayed according to the calculated matching degree.

3. The method of claim 1, further comprising:
recognizing a digital landing marker provided in a vertiport from the vehicle landing image; and
calculating a location and direction of the aerial vehicle using the recognized digital landing marker.

4. The method of claim 3, wherein the vertiport includes a first area corresponding to a landing area TLOF, and
in the generating of the landing guide object, a landing guide object for guiding the aerial vehicle to enter the first area of the vertiport is generated based on the location and direction of the aerial vehicle.

5. The method of claim 4, wherein the vertiport further includes a second area corresponding to a landing stage entry area (FATO) and a third area corresponding to a safety area, and
in the generating of the landing guide object, landing guide objects for sequentially guiding entry into the third area, the second area, and the first area of the aerial vehicle are generated based on the location and direction of the aerial vehicle for each of the first to third areas.

6. The method of claim 5, wherein the landing guide objects for each of the first to third areas are displayed differently.

7. The method of claim 1, further comprising:
generating a route guidance object based on a flight route for flight to a destination of the aerial vehicle; and
displaying a route guidance image based on the generated route guidance object,
wherein the route guidance image includes a first route guidance image or a second route guidance image according to a horizontal distance to the aerial vehicle and the vertiport.

8. The method of claim 7, wherein, in the displaying of the second route guidance image, a vertiport object indicating the vertiport is displayed on one area of a screen, and the transparency of the vertiport object is adjusted when the aerial vehicle approaches the vertiport within a predetermined distance.

9. The method of claim 7, wherein, in the displaying of the second AR route guidance image, the second AR route guidance image is displayed by adjusting a curve of the route guidance object indicating a route between the vehicle and the vertiport.

10. A program stored in a computer-readable recording medium including a program code for executing the method of assisting landing of an aerial vehicle according to claim 1.

11. A computer-readable recording medium on which a program for executing the method of assisting landing of an aerial vehicle according to claim 1 is recorded.

12. An apparatus for assisting landing of an aerial vehicle based on an image, comprising:
an image acquisition unit installed on the aerial vehicle to acquire a landing image of the aerial vehicle;
a guidance object generation unit generating a landing guide object for guiding the landing of the aerial vehicle;
a guide image generation unit generating an image obtained by combining the acquired landing image of the aerial vehicle and the landing guide object; and
a display unit displaying the generated landing assistance image.

13. The apparatus of claim 12, further comprising:
an image analysis unit detecting a landing area from the landing image and calculating a matching degree between the landing guide object and the detected landing area,
wherein the display unit displays the landing guide objects differently according to the calculated matching degree.

14. The apparatus of claim 12, wherein the image analysis unit recognizes a digital landing marker provided in the vertiport from the landing image, and calculates the location and direction of the aerial vehicle using the recognized digital landing marker.

15. The apparatus of claim 14, wherein the vertiport includes a first area corresponding to a landing area TLOF, and the guidance object generation unit generates a landing guide object for guiding the aerial vehicle to enter the first area of the vertiport based on the location and direction of the aerial vehicle.

16. The apparatus of claim 15, wherein the vertiport further includes a second area corresponding to a landing stage entry area (FATO) and a third area corresponding to a safety area, and
the guidance object generation unit generates landing guide objects for sequentially guiding entry into the third area, the second area, and the first area of the aerial vehicle based on the location and direction of the aerial vehicle for each of the first to third areas.

17. The apparatus of claim 16, wherein the landing guide objects for each of the first to third areas are displayed differently.

18. The apparatus of claim 12, wherein the guidance object generation unit generates a route guidance object based on a flight route for flight to a destination of the aerial vehicle,
the display unit displays the route guidance image generated based on the generated guidance object, and
the guidance image includes a first route guidance image or a second route guidance image according to a horizontal distance to the vehicle and the vertiport.

19. The apparatus of claim 18, wherein the second AR route guidance image displays a vertiport object indicating the vertiport on one area of a screen, and the transparency of the vertiport object is adjusted when the aerial vehicle approaches the vertiport within a predetermined distance.

20. The apparatus of claim 18, wherein the second AR route guidance image is displayed by adjusting a curve of the route guidance object indicating a route between the vehicle and the vertiport.
